(19) United States
(12) Patent Application Publication
(10) Pub. No.: US 2015/0331751 A1
(43) Pub. Date: Nov. 19, 2015

(54) METHOD OF PROCESSING DATA, SYSTEM AND STORAGE MEDIUM

(71) Applicant: FUJITSU LIMITED, Kawasaki-shi (JP)

(72) Inventor: Toshiaki SAEKI, Kawasaki (JP)

(73) Assignee: FUJITSU LIMITED, Kawasaki (JP)

(21) Appl. No.: 14/669,597

(22) Filed: Mar. 26, 2015

(30) Foreign Application Priority Data
May 14, 2014 (JP) 2014-100794

(51) Int. Cl. G06F 11/14; G06F 17/30

(52) U.S. Cl. CPC G06F 11/1402; G06F 17/30312

(57) ABSTRACT

A method of processing data, includes: storing definition information in which a first identifier for identifying a type of data and a condition for executing predetermined processing are associated with each other; receiving the data; first determining whether or not information in a predetermined region of the received data satisfies the condition associated with the first identifier in the definition information in a case where a second identifier included in the received data matches the first identifier in the definition information; and second determining, based on the first determining, that the received data is restored.

### CROSS-REFERENCE TO RELATED APPLICATION

This application is based upon and claims the benefit of priority of the prior Japanese Patent Application No. 2014-100794, filed on May 14, 2014, the entire contents of which are incorporated herein by reference.

### FIELD

The embodiments discussed herein are related to a method of processing data, a system and a storage medium.

### BACKGROUND

In software development, an object-oriented language is sometimes used. The object-oriented language is, for example, Java (Registered Trademark) or C++. Object communication is often used as communication in software developed by using an object-oriented language in view of development efficiency. In object communication, an object is converted to a byte sequence through serialization and put on a massage at the time of transmission of the message. Moreover, in object communication, the byte sequence on the message is inversely converted to the object through deserialization at the time of reception of the message.

In object communication, the load on a central processing unit (CPU) is high. There is a case where the throughput decreases because the CPU becomes a bottleneck. In particular, in an application in which a large volume of data is exchanged between nodes by using object communication, for example, large-volume-data processing and complex event processing (CEP), a decrease in throughput caused by object communication becomes a problem.

As a related conventional art, for example, a transmitting-side apparatus that creates communication data by omitting data that are not to be transmitted instead of serially arranging all the data at the time of serialization of a data object is known. As another related conventional art, an information processing apparatus that changes a serialization and deserialization executing unit by using plug-in in accordance with a communication protocol is known. As another related conventional art, a technique of object communication for serializing and transmitting an object at the transmission side and deserializing and referring to the object at the reception side is known.

As the related arts, for example, Japanese Laid-open Patent Publication No. 2008-203959, Japanese Laid-open Patent Publication No. 2009-140245, Japanese Laid-open Patent Publication No. 2009-289272, M. Cherniack, H. Balakrishnan, M. Balazinska, D. Carney, U. Cetintemel, Y. Xing, and S. Zdonik, “Scalable Distributed Stream Processing”, Proceedings of the 2003 CIDR Conference, Jeffrey Dean and Sanjay Ghemawat, “MapReduce: Simplified Data Processing on Large Clusters”, COMMUNICATIONS OF THE ACM January 2008/Vol. 51, No. 1, “Java™ Object Serialization Specification”, JDK 1. 2, Nov. 30, 1998, “Developer Guide-Protocol Buffers”, Apr. 2, 2012, and Sadayuki Furuhashi, “Study on Message Expressing Method for Distribution System”, Graduate School of University of Tsukuba, Systems and Information Engineering, master's thesis, March 2012 are known.

### SUMMARY

According to an aspect of the invention, a method of processing data, includes: storing definition information in which a first identifier for identifying a type of data and a condition for executing predetermined processing are associated with each other; receiving the data; first determining whether or not information in a predetermined region of the received data satisfies the condition associated with the first identifier in the definition information in a case where a second identifier included in the received data matches the first identifier in the definition information; and second determining, based on the first determining, that the received data is restored.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a processing method according to an embodiment;

FIG. 2 illustrates a processing example of serialization and deserialization of an object;

FIG. 3 illustrates an example of a system configuration of a processing system according to the embodiment;

FIG. 4 illustrates an example of a hardware configuration of nodes;

FIG. 5 illustrates an example of a definition information table of a receiving node;

FIG. 6 illustrates an example of a definition information table of a transmitting node;

FIG. 7 illustrates an example of statistical information transmitted to a management apparatus by the transmitting node;

FIG. 8 illustrates an example of statistical information transmitted to the management apparatus by the receiving node;

FIG. 9 illustrates an example of definition information transmitted to the transmitting node and the receiving node by the management apparatus;

FIG. 10 illustrates an example of a speed-up message that includes a speed-up field transmitted and received by the transmitting node and the receiving node;

FIG. 11 illustrates an example of a functional configuration of the management apparatus according to the embodiment;

FIG. 12 illustrates an example of a functional configuration of the transmitting node according to the embodiment;

FIG. 13 illustrates an example of a functional configuration of the receiving node according to the embodiment;

FIG. 14 is a flow chart illustrating an example of a procedure of data receiving processing of the receiving node according to the embodiment;

FIG. 15 is a flow chart illustrating an example of a procedure of data receiving processing of the transmitting node according to the embodiment;

FIG. 16 is a flow chart illustrating an example of a procedure of definition information table updating processing of the receiving node according to the embodiment;

FIG. 17 is a flow chart illustrating an example of a procedure of speed-up object deciding processing of the management apparatus according to the embodiment;

FIG. 18 is a flow chart illustrating an example of a procedure of statistical information calculating processing of the receiving node according to the embodiment;

FIGS. 19A, 19B, 19C, and 19D illustrate a first example of speed-up object deciding processing of the management apparatus according to the embodiment;

FIGS. 20A, 20B, 20C, and 20D illustrate a second example of speed-up object deciding processing of the management apparatus according to the embodiment;

FIG. 21 illustrates an example of a system configuration of a processing system according to another embodiment; and

FIG. 22 illustrates an example of a functional configuration of a node according to the embodiment.

### DESCRIPTION OF EMBODIMENTS

In the conventional arts, the CPU's processing cost of data recovery processing such as deserialization of received data is still high. This causes a decrease in throughput of object communication.

Embodiments of a processing system and a processing method according to the present disclosure are described below in detail with reference to the drawings.

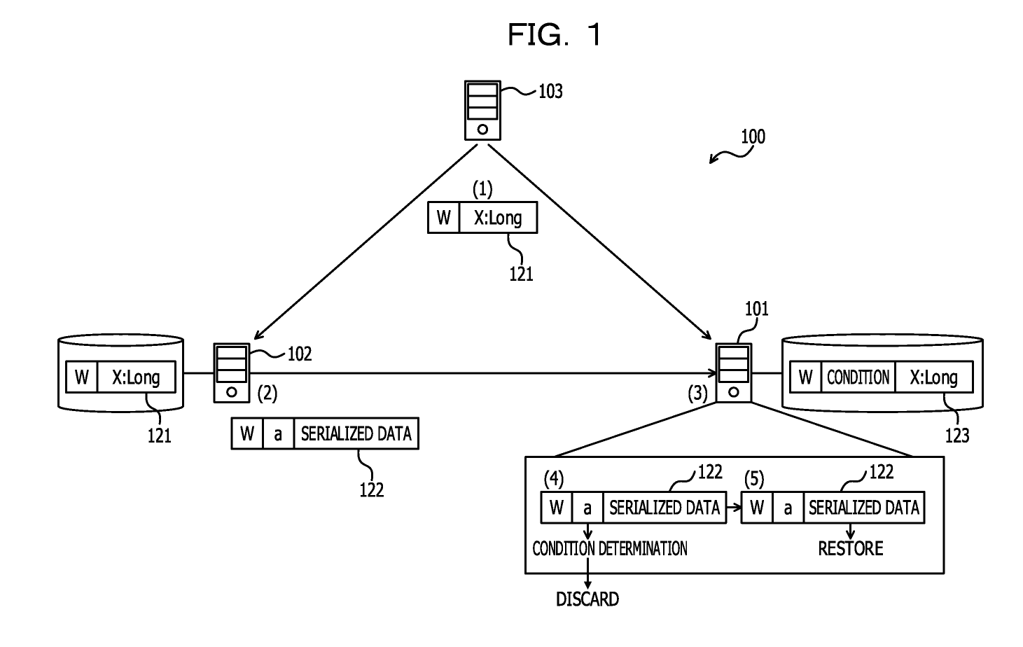

FIG. 1 illustrates an example of the processing method according to the embodiment. In FIG. 1, a processing system 100 includes a processing apparatus 101, a processing apparatus 102, and a management apparatus 103. The processing system 100 is a system in which data is exchanged between the processing apparatuses to perform processing such as composite event processing.

The composite event processing is processing for making judgments and analyses by applying conditions loaded on a memory to data arriving one after another in order to judge and analyze the data from a device such as a sensor in a short time. According to the composite event processing, it becomes possible to process an enormous volume of data in a short time.

The processing apparatus 101 is a receiving-side computer that receives data from the processing apparatus 102 and processes the data. The processing apparatus 102 is a transmitting-side computer that transmits data to the processing apparatus 101. The management apparatus 103 is a computer that manages the processing apparatus 101 and the processing apparatus 102.
The data includes an identifier for identifying the type of the data. The type of data is a collection of data that are handled in the same way in a computer. Examples of the type of data include an object type, an array type, and a list type.

In the following description, the “object type” is taken as an example of the type of data and a “message” transmitted and received through object communication is taken as an example of the data.

In software development, an object-oriented language is often employed. The object-oriented language is, for example, Java or C++. The object-oriented language is a language suitable for programming of software made up of functional parts called objects.

An object is data reproduced on a computer by modeling a physical or abstract entity existing in the real world as an assembly of an attribute and an operation. The object has an item (member) identified by an item name. The member is, for example, a field, which is a variable, or a method, which is a function.

In communication in software developed by using an object-oriented language, object communication is often used in view of development efficiency. Object communication is a technique that makes it possible to transmit and receive an object over a network on which only a byte sequence can be generally transmitted and received. In object communication, an object is converted to a byte sequence through serialization and is put on a massage by a transmitting-side computer, and the byte sequence on the message is inversely converted to the object through deserialization by a receiving-side computer.

The message is data that is transmitted and received. The message is, for example, a minimum transmission reception unit in an application layer for transmitting and receiving data. Serialization is processing for encoding (serializing) data. For example, serialization is processing for serializing an object type, the type of a field of the object, and a value of the field to a byte sequence and placing them in a message in order to transmit and receive the object via a network.

Moreover, in serialization, in a case where one object stores another object as a value of a field, the field of the object is recursively stored. Moreover, in serialization, a method of the object and a static variable and a constant value in the field are not serialized to a byte sequence and is not placed in a message.

Deserialization is processing for restoring encoded (serialized) data. For example, deserialization is processing for restoring the object type, the type of the field of the object, and the value of the field from the byte sequence. The object type and the type of field are restored by reflection. Reflection is a technique for dynamic typing in a statically typed language such as Java. As used herein, reflection means restoring a type definition of an object from a character string or an eigenvalue indicative of an object type in data by referring to a database or the like.

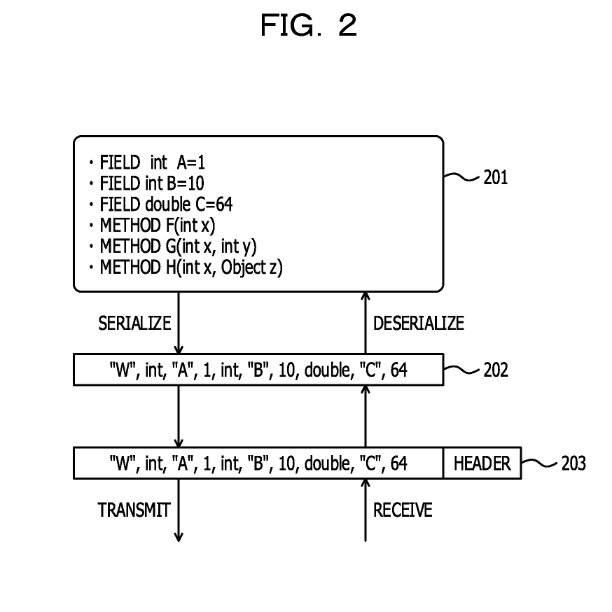

An example of processing for serializing and deserializing an object is described with reference to FIG. 2.

FIG. 2 illustrates an example of processing for serializing and deserializing an object. In FIG. 2, an object 201 is an object of an object type W and has fields and methods as members. The object type W has int A, int B, and double C as the fields and has F (int x), G (int x, int y), and H (int x, Object z) as the methods.

“A”, “B”, and “C” are field names for identifying the fields, and “F”, “G”, and “H” are method names for identifying the methods. Meanwhile, “int” and “double” of the fields are types of the fields. The types of fields are formats concerning handling of data in a computer. The object 201 has A=1, B=10, and C=64 as values of the fields.

A byte sequence 202 is obtained by serializing the object 201. At the time of serialization, the object type, the types of the fields of the object, the field names, and the values of the fields are converted to numerical values. In this way, the byte sequence 202 is generated. Meanwhile, the methods are common to all the object types W and are therefore not included in the byte sequence 202.

In the byte sequence 202, the object type “W” is replaced with a numerical value converted from a character string or with a predetermined numerical value. The byte sequence 202 is restored from the converted numeric value by reflection at the time of deserialization. Note that the object type “W” is restored from the numerical value converted from the character string or from the predetermined numerical value by reflection. Along with this, the types of the fields of the object and the methods of the object are also restored (automatically determined from the object type). Furthermore, the values of the fields stored in the byte sequence 202 are restored.

A message 203 is obtained by adding a header to the byte sequence 202. The header is a portion in which information about the message is stored. In the header, information used for transmission and reception of the message such as a sender and a recipient of the message, a server via which the message is transmitted, and the title of the message is stored. The message 203 is assembled from the byte sequence 202 at the time of transmission, and the byte sequence 202 is extracted from the message 203 at the time of reception.

A receiving-side computer receives the message 203, extracts the byte sequence 202 from the message 203, and deserializes all the objects and fields present in the byte sequence 202. Then, the receiving-side computer determined whether or not a condition is satisfied by referring to the values of the fields of the deserialized byte sequence 202, that is, the object 201.

The condition is used to determine whether or not predetermined processing is performed on data received by the receiving-side computer. The predetermined processing is, for example, processing of analyzing the data. For example, the receiving-side computer executes a query made up of preprocessing and postprocessing. The preprocessing is processing for determining whether or not the received data satisfies the condition. The postprocessing is processing for executing predetermined processing such as analysis on data that has been determined in the preprocessing as data that satisfies the condition.

Even in a case where the receiving-side computer restores the object 201 by deserializing the received byte sequence 202, the receiving-side computer sometimes does nothing and discards the object 201 generated by deserialization in a case where the receiving-side computer determines that the condition is not satisfied by referring to only part of the object 201. Furthermore, even in a case where the receiving-side computer restores the object 201 by deserializing the received byte sequence 202, the receiving-side computer sometimes transmits the received byte sequence 202 to another computer without referring to the fields at all.

That is, even in a case where the receiving-side computer refers to only one or some of the fields or does not refer to the fields at all, a CPU is used to generate the object 201 by deserializing the received byte sequence 202 in a case where the receiving-side computer restores the object 201 by deserializing the received byte sequence 202. This increases the load on the CPU of the receiving-side computer, thereby causing a decrease in throughput of object communication.

In view of this, in the present embodiment, the processing apparatus 101 restores data in accordance with whether or not the received data (for example, the message 122) satisfies a condition for executing predetermined processing stored in association with an identifier for identifying the type of the data. This makes it unnecessary to perform unnecessary restoring processing of data that does not include a value used for the predetermined processing. An example of data processing of the processing system 100 according to the present embodiment is described below.

(1) The management apparatus 103 transmits definition information 121 to the processing apparatus 101 and the processing apparatus 102. The definition information 121 includes an identifier for identifying an object type and information indicative of a predetermined region in a message (for example, the message 122) in which a value used for preprocessing of the object type is embedded.

The value used for the preprocessing is a value of a field included in the object. There are cases where one message includes a plurality of values used for preprocessing. The definition information 121 may, for example, include, for all of the values of the fields of the object, information indicative of a predetermined region in the message. The information indicative of a predetermined region is information indicative of the position of the value of the field and data size of the value of the field in the message.

The processing apparatus 101 causes the identifier for identifying the object type included in the received definition information 121 to be stored in a storage device as definition information 123 so that the identifier is associated with the condition for executing the predetermined processing. Furthermore, the information indicative of the predetermined region included in the received definition information 121 is stored in the storage device as one condition for executing the predetermined processing.

The predetermined processing is processing such as analysis processing executed on an object of the object type identified by the identifier included in the definition information 121. For example, in a case where the processing apparatus 101 is a computer that executes a query, the predetermined processing is postprocessing in the query. The processing apparatus 102 causes the received definition information 121 to be stored in a storage device.

In the example of FIG. 1, the definition information 121 is information in which “W”, which is an identifier for identifying the object type, and “X:Long”, which is information indicative of a predetermined region in the message 122 in which a value used in the preprocessing of the object type identified by “W” is embedded, are associated with each other. “X” is information indicative of the position of the embedded value used for the preprocessing. “Long” is information indicative of the data size of the embedded value used for the preprocessing.

(2) The processing apparatus 102 serializes an object in a case where the processing apparatus 102 transmits the object to the processing apparatus 101. In a case where the object is an object of the object type identified by the identifier stored in the definition information 121, the processing apparatus 102 transmits a message 122 including the identifier for identifying the object type and the serialized object to the processing apparatus 101.

In the example of FIG. 1, in a case where the object type of the transmitted object is “W”, the processing apparatus 102 causes “W”, which identifies the object type, and the value “a”, which is used in the preprocessing, to be embedded in a predetermined region whose position is “X” and whose data size is “Long” in the message 122. Then, the processing apparatus 102 transmits the message 122 including “W”, “a”, and the serialized data to the processing apparatus 101. The serialized data is data obtained by serializing the transmitted object.

(3) The processing apparatus 101 receives the message 122 from the processing apparatus 102.

(4) The processing apparatus 101 determines whether or not the identifier for identifying the object type included in the received message 122 is stored in the definition information 123. In a case where the identifier is stored in the definition information 123, the processing apparatus 101 determines whether or not the information in the predetermined region of the message 122 satisfies the condition for executing the predetermined processing associated with the identifier included in the message 122.

In the example of FIG. 1, “W”, which identifies the object type included in the received message 122, is stored in the definition information 123. Therefore, the processing apparatus 101 determines whether or not the value “a” in the predetermined region whose position is “X” and whose data size is “Long” satisfies the condition for executing the predetermined processing associated with “W”.

(5) The processing apparatus 101 restores the serialized data in the message 122 in accordance with the result of the determination. For example, in a case where the processing apparatus 101 determines that the condition is satisfied, the processing apparatus 101 restores the serialized data in the message 122. In a case where the processing apparatus 101 determines that the condition is not satisfied, the processing apparatus 101 discards the message 122 without deserializing the serialized data in the message 122, that is, without generating the object.

In this way, according to the processing apparatus 101, in a case where an identifier included in received data (for example, the message 122) is stored in the definition information 123, it is determined whether or not information in a predetermined region of the data satisfies a condition for executing the predetermined processing associated with the identifier included in the data, and the received data can be restored in accordance with the result of the determination.

This makes it unnecessary for the processing apparatus 101 to generate an object by deserializing data in a case where the data is one that does not include a value used for processing such as analysis processing and is discarded even if the object is generated by deserialization. That is, it is unnecessary to perform unnecessary generation of an object through deserialization. For example, in composite event processing, many data are discarded as not satisfying the condition for executing the predetermined processing, and therefore the processing apparatus 101 can markedly reduce unnecessary generation of an object through deserialization.

Note that the processing apparatus 101 sometimes refers to only a value(s) of one or some of the fields instead of referring to the values of all of the fields of the object in determining whether or not the condition for executing the predetermined processing is satisfied. Therefore, the definition information 121 may include, for only the value(s) of one or some of the fields referred to in determination as to whether or not the condition is satisfied, information indicative of a predetermined region in a message.

(Example of System Configuration of Processing System 100)

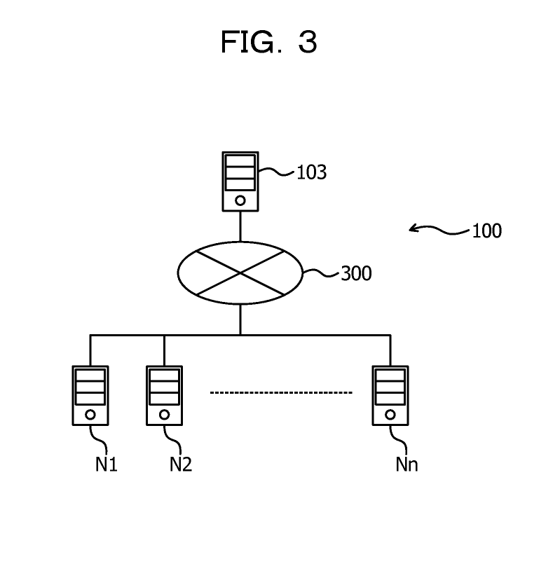

FIG. 3 illustrates an example of a system configuration of the processing system 100 according to the embodiment. In FIG. 3, the processing system 100 includes nodes N1 to Nn (n is a natural number of 2 or more) and the management apparatus 103. The nodes N1 to Nn and the management apparatus 103 are coupled to each other via a wired or wireless network 300. The network 300 is, for example, a local area network (LAN), a wide area network (WAN), or the Internet.

Each of the nodes N1 to Nn is a computer that transmits and receives data. Each of the nodes N1 to Nn and the management apparatus 103 is, for example, a server or a personal computer (PC). In the following description, out of the nodes N1 to Nn, a receiving-side node that receives data is sometimes referred to as a “receiving node Ni” (i=1, 2, . . . , n), and a transmitting-side node that transmits data is sometimes referred to as a “transmitting node Nj” (j≠i, j=1, 2, . . . , n)

The processing apparatus 101 illustrated in FIG. 1 corresponds to the receiving node Ni. The processing apparatus 102 illustrated in FIG. 1 corresponds to the transmitting node Nj. Note that each of the nodes N1 to Nn can be a receiving node Ni or a transmitting node Nj.

(Example of Hardware Configuration of Nodes N1 to Nn)

Next, an example of a hardware configuration of each of the nodes N1 to Nn illustrated in FIG. 3 is described. In the following description, each of the nodes N1 to Nn is simply referred to as a “node N”.

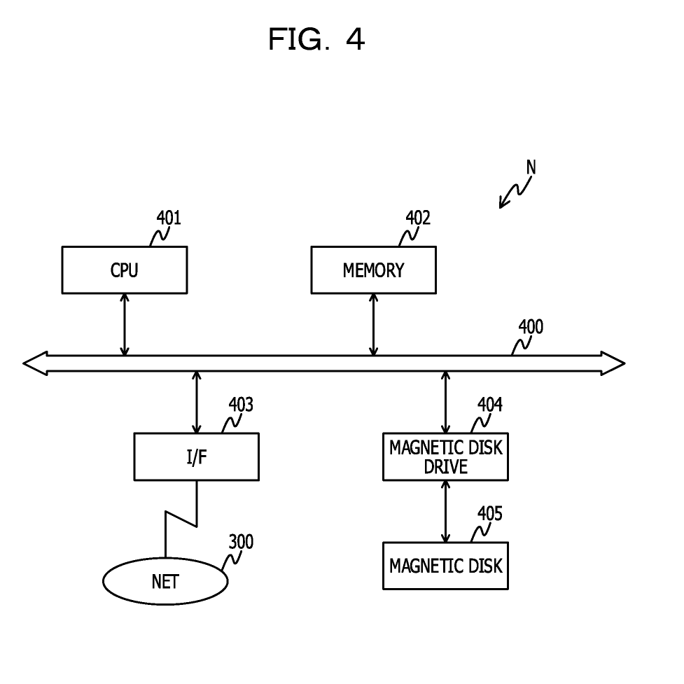

FIG. 4 illustrates an example of a hardware configuration of each of the nodes N1 to Nn. In FIG. 4, the node N includes a CPU 401, a memory 402, an interface (I/F) 403, a magnetic disc drive 404, and a magnetic disc 405. These constituent members are coupled to each other via a bus 400.

The CPU 401 controls the whole node N. The memory 402 has, for example, a read only memory (ROM), a random access memory (RAM), and a flash ROM. For example, various programs are stored in the flash ROM and the ROM, and the RAM is used as a work area of the CPU 401. The programs stored in the memory 402 are loaded to the CPU 401, and thus coded processing is executed by the CPU 401.

The I/F 403 is coupled to the network 300 via a communication line and is coupled to other computers (for example, another node N or the management apparatus 103) via the network 300. The I/F 403 is an interface between the network 300 and the inside and controls input and output of data to and from the other computers. For example, a modem or a LAN adaptor is used as the I/F 403.

The magnetic disc drive 404 controls read/write of data from/to the magnetic disc 405 under control of the CPU 401. The magnetic disc 405 stores therein data written under control of the magnetic disc drive 404.

Note that the node N may include, for example, a solid state drive (SSD), a keyboard, a mouse, and a display in addition to the above-mentioned constituent members. An example of a hardware configuration similar to that of the node N described above can be employed as the management apparatus 103 illustrated in FIG. 3.

(Example of Definition Information Table 500)

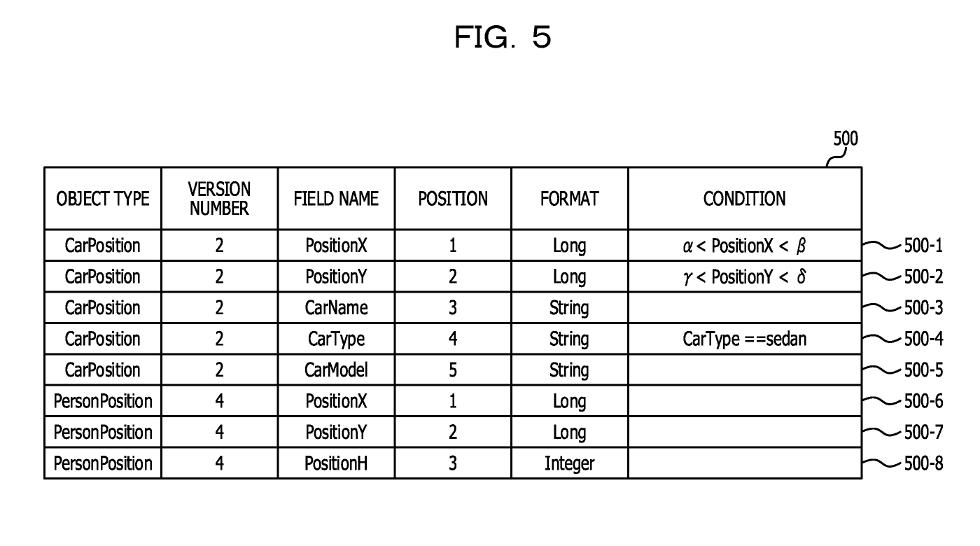

FIG. 5 illustrates an example of a definition information table 500 of the receiving node Ni. In FIG. 5, the definition information table 500 of the receiving node Ni is created and updated by an updating section 1305 of the receiving node Ni that will be described later and is stored in the memory 402 or the magnetic disc 405 of the receiving node Ni.

The definition information table 500 has the following items: “object type”, “version number”, “field name”, “position”, “format”, and “condition”. In the definition information table 500, information is set in each of the items, definition information (for example, definition information 500-1 to 500-8) is stored as a record.

The “object type” is an identifier for identifying the type of object. The “version number” is a number indicative of a version of definition information. The “version number” is defined for each object type and is incremented every time the definition is updated. The “field name” is an identifier for identifying a field of the object type. Among the fields of the object type, a field name of a field that is embedded in a message is stored. The “position” indicates an order in which the field of the field name of the record is stored in a message. The “format” indicates a format in which the field of the field name of the record is stored in the message. The “condition” is a condition for the value of the field of the object type.

The information of the “field name” stored in the definition information table 500 is embedded in a predetermined region in the message that is different from a byte sequence obtained by serializing the object of the “object type”. In the following description, the field name embedded in the predetermined region in the message is sometimes referred to as a “speed-up field name”, and the object type having the speed-up field name is sometimes referred to as a “speed-up object type”. Furthermore, a message carrying an object identified by the speed-up object type is sometimes referred to as a “speed-up message”.

In the example of FIG. 5, CarPosition and PersonPosition are defined as speed-up object types in a message. The version number of CarPosition is 2, and the version number of PersonPosition is 4. PositionX, PositionY, CarName, CarType, and CarModel are defined as speed-up field names in the speed-up object type CarPosition. PositionX, PositionY, and PositionH are defined as speed-up field names in the speed-up field type PersonPosition.

The positions and formats of these field names on a message are indicated by the items “position” and “format” in the definition information table 500. In the example of FIG. 5, “Long” is a fixed-length field of 8 bytes, “Integer” is a fixed-length field of 4 bytes, and “String” is a variable-length field. For example, in a variable-length field, the length of the field is written at the start of a field storage region of the message. In embedding a value of a field in a message, a fixed-length field and a variable-length field may be recorded in this order. In this case, since the position of the fixed-length field is fixed, the position of the fixed-length field on the message can be easily specified.

The position of a variable-length field on a message varies from one message to another. Therefore, to specify the position of a variable-length field, a process of analyzing description of the length at the start so that the position of a next variable-length field is specified is repeated.

For example, assume that the length of CarName is 10, the length of CarType is 14, and the length of CarModel is 16. In this case, since CarName is described at the start of the variable-length field, the position of CarName in the message is 16 (8+8) bytes from the start of the field storage position. The position of CarType is obtained by adding the length of CarName to this, and is therefore 26 (16+10) bytes from the start of the field storage position. Similarly, the length of CarModel is 40 (26+14) bytes from the start of the field storage position.

In the example of FIG. 5, a condition is defined in the field names PositionX, PositionY, and CarType in the object type CarPosition. Note that in a case where no condition is defined in the field name of the definition information table 500 of the receiving node Ni, the condition field may be empty.

(Example of Definition Information Table 600)

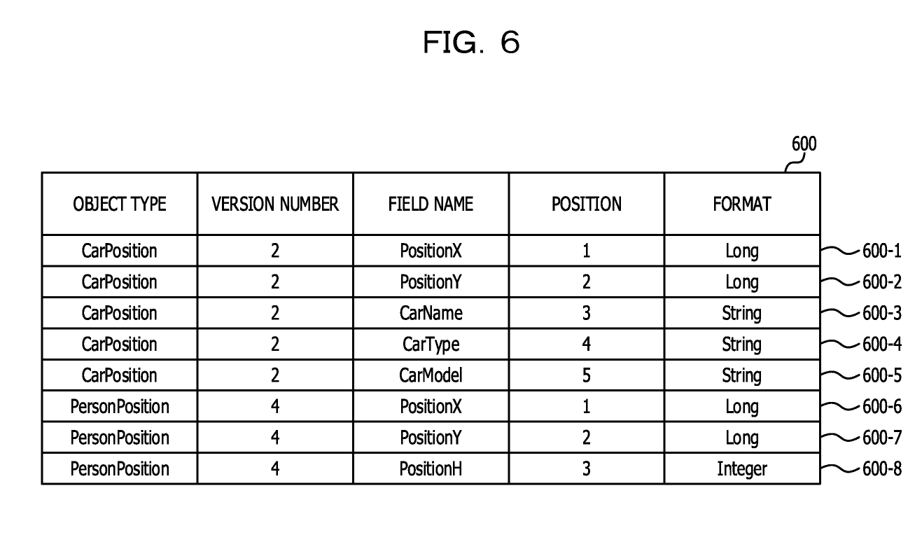

FIG. 6 illustrates an example of a definition information table 600 of the transmitting node Nj. In FIG. 6, the definition information table 600 of the transmitting node Nj is, for example, created and updated by an updating section 1206 of the transmitting node Nj that will be described later and is stored in the memory 402 or the magnetic disc 405 of the transmitting node Nj.

The definition information table 600 has the following items: “object type”, “version number”, “field name”, “position”, and “format”. In the definition information table 600, information is set in each of the items, and definition information (for example, definition information 600-1 to 600-8) is stored as a record.

The items “object type”, “version number”, “field name”, “position”, and “format” of the definition information table 600 have the same information as those of the definition information table 500.

(Example of Statistical Information 700)

An example of statistical information 700 transmitted to the management apparatus 103 by the transmitting node Nj is described.

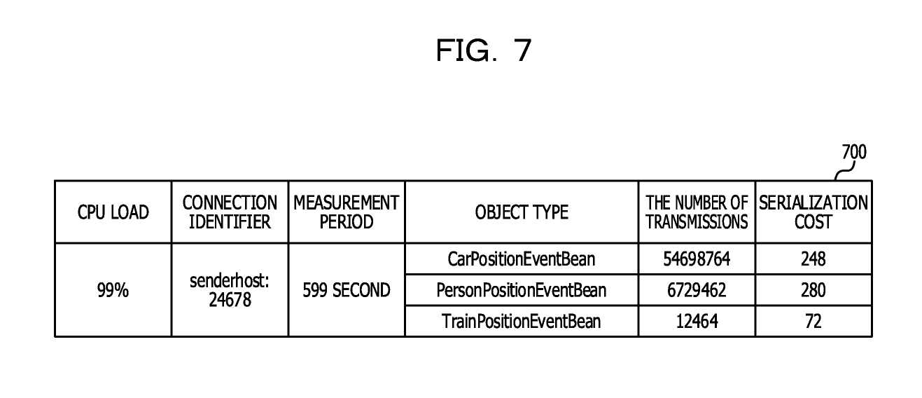

FIG. 7 illustrates an example of the statistical information 700 transmitted to the management apparatus 103 by the transmitting node Nj. In FIG. 7, the statistical information 700 transmitted to the management apparatus 103 by the transmitting node Nj is, for example, calculated by a calculating section 1205 of the transmitting node Nj and transmitted to the management apparatus 103 by a communication section 1204 of the transmitting node Nj.

In the statistical information 700, “CPU load”, “connection identifier”, “measurement period”, “object type”, “the number of transmissions”, and “serialization cost” are recorded. The “CPU load” refers to a CPU load of the transmitting node Nj. For example, the average value of CPU usage rates during the measurement period may be used as the CPU load. The “connection identifier” is for identifying connection between the transmitting node Nj and the receiving node Ni. The connection identifier is used to distinguish connections in a case where different object types and field names are used in the connections. In a case where the same definition is used in all of the connections, the transmitting node Nj does not have to transmit the connection identifier to the management apparatus 103. The connection identifier is same as the connection identifier transmitted to the management apparatus 103 by the receiving node Ni, and may be therefore omitted.

The “measurement period” is a period in which the number of transmissions for each object type is measured. For example, the management apparatus 103 notifies the transmitting node Nj of a measurement period in advance. The “number of transmissions” for each object type is the number of times an object identified by the object type is transmitted by the transmitting node Nj during the measurement period. The number of transmissions for each object type is the same as the number of receptions for each object type transmitted to the management apparatus 103 by the receiving node Ni, and may be therefore omitted. The “serialization cost” for each object type is a cost of serialization of an object identified by the object type. The serialization cost may be a CPU time taken for serialization of the object identified by the object type. This serialization cost may be omitted in a case where the serialization cost is statically determined. In a case where the serialization cost dynamically changes, an average value per certain time may be used.

The transmitting node Nj can calculate the serialization cost, for example, by using the following first through third methods.

First Method: Method using actual measurement. The transmitting node Nj measures a CPU time actually taken for serialization at the rate of 1 time per predetermined times and calculates the average of the measured times as the serialization cost. Note, however, that measurement of a CPU time causes a high load on the CPU and may therefore be performed by simulation or the like.

Second Method: Method using model (1). The transmitting node Nj counts the number of fields including an object or a field, and uses the counted number as the serialization cost. Since reflection costs most, this method uses the number of reflections as the serialization cost.

For example, the serialization cost of the following Java class is calculated.

Class CarPosition {

long PositionX
long PositionY
int PositionH
String CarName
String CarType
String CarModel

}

Since there is reflection of CarPosition class itself and there are three fields (CarName, CarType, and CarModel) that are not Java primitive and perform reflection in restoration, the serialization cost is 1+3=4. In the case where the length of String is short, calculation of the serialization cost using Second Method is effective.

Third Method: Method using model (2). The transmitting node Nj measures the size of an object and uses the measured size as the serialization cost. The size of the object is the total of data sizes of all the fields of the object. In a case where the object is a significantly large object such as a moving image file, a serialization time is determined based on the size of the object, and therefore this method is effective.

(Example of Statistical Information 800)

An example of statistical information 800 transmitted to the management apparatus 103 by the receiving node Ni is described.

FIG. 8 illustrates an example of the statistical information 800 transmitted to the management apparatus 103 by the receiving node Ni. The statistical information 800 transmitted to the management apparatus 103 by the receiving node Ni is, for example, created by a calculating section 1304 of the receiving node Ni and transmitted to the management apparatus 103 by a communication section 1301 of the receiving node Ni.

In the statistical information 800 transmitted to the management apparatus 103 by the receiving node Ni, “CPU load”, “connection identifier”, “measurement period”, “object type”, “the number of receptions”, “field name”, “the number of references”, and “deserialization cost” are recorded.

The “CPU load” refers to a CPU load of the receiving node Ni. For example, the average value of CPU rates during a measurement period may be used as the CPU load. The “connection identifier” is used to distinguish connections in a case where different object types and field names are used in the connections. In a case where the same definition is used in all of the connections, the receiving node Ni does not have to transmit the connection identifier to the management apparatus 103.

The “measurement period” is a period in which the number of receptions for each object type and the number of references for each field name are measured. For example, the management apparatus 103 notifies the receiving node Ni of the measurement period in advance. The “number of receptions” for each object type is the number of times the receiving node Ni receives an object identified by the object type during the measurement period. The “number of references” for each field name is the number of times a determining section 1302 of the receiving node Ni refers to the field name in the object during the measurement period. The receiving node Ni may measure, for all of the object types, the number of receptions for each object type or may measure, only for object types whose number of receptions is larger than a certain number, the number of receptions for each object type. The receiving node Ni may measure, for all of the object types, the number of receptions for each object type or may transmit, only for object types whose number of receptions is larger than a certain number, the number of receptions for each object type to the management apparatus 103. The receiving node Ni may measure, for all of the field names, the number of references for each field name or may measure, only for field names whose number of references is larger than a certain number, the number of references for each field name. The receiving node Ni may measure, for all of the field names, the number of references for each field name or may transmit, only for field names whose number of references is larger than a certain number, the number of references for each field name to the management apparatus 103. The “deserialization cost” for each object type is a cost desired to deserialize and generate an object identified by the object type. The deserialization cost for each object type may be a CPU time taken to deserialize and generate an object identified by the object type. This deserialization cost may be omitted in a case where the deserialization cost is statically determined. In a case where the deserialization cost dynamically changes, an average value per certain time may be used.

(Example of Definition Information 900)

An example of definition information 900 transmitted to the transmitting node Nj and the receiving node Ni by the management apparatus 103 is described.

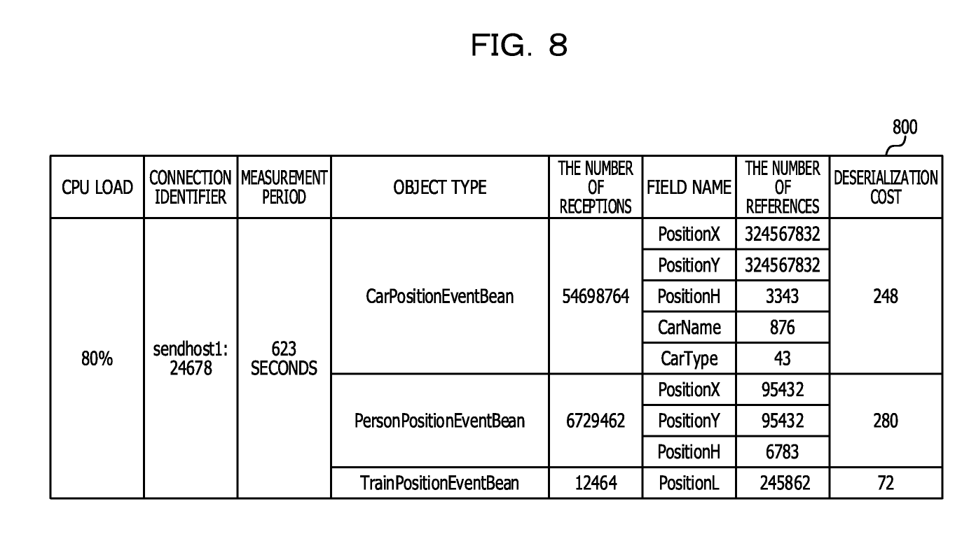

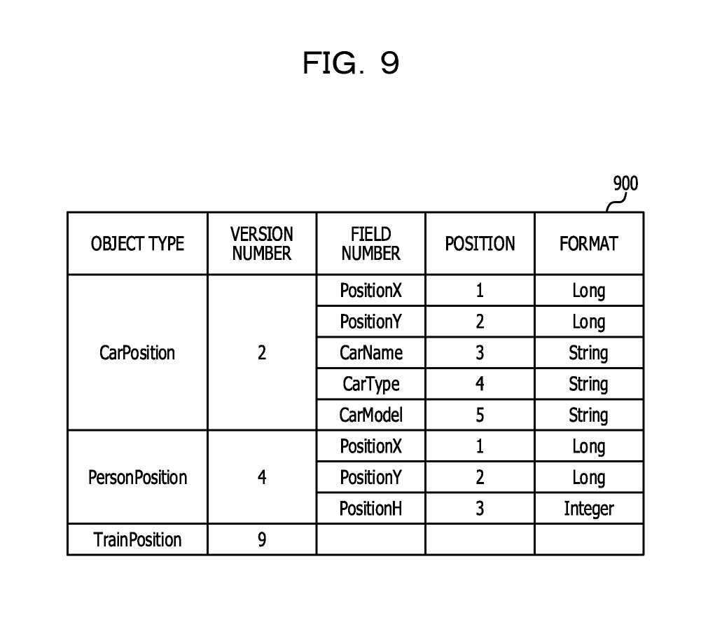

FIG. 9 illustrates an example of the definition information 900 transmitted to the transmitting node Nj and the receiving node Ni by the management apparatus 103. The definition information 900 transmitted to the transmitting node Nj and the receiving node Ni by the management apparatus 103 is, for example, created by a deciding section 1102 of the management apparatus 103 and stored in the memory 402 or the magnetic disc 405 of the management apparatus 103. The definition information 900 is, for example, transmitted to the transmitting node Nj and the receiving node Ni by a notifying section 1103 of the management apparatus 103.

In the definition information 900 transmitted to the transmitting node Nj and the receiving node Ni by the management apparatus 103, “object type”, “version number” for each object type, “field name”, and “position” and “storage format” of a field identified by the field name are stored so as to be associated with each other.

The “object type” is an identifier for identifying the type of object. The “version number” is a number indicative of a version of definition. The version number is defined for each object type and is increased when the definition is updated. The “field name” is an identifier for identifying a field of the object type. Among fields of the object type, a field embedded in a message is stored in the “field name”. The “position” indicates the order in which the field of the field name of the record is stored in the message. The “format” indicates a format in which the field of the field name of the record is stored in the message. Furthermore, an object type whose field name, position, and format are all null is not handled as an object embedded in a message.

The receiving node Ni that has received the definition information 900 transmitted by the management apparatus 103 updates the definition information table 500 of the receiving node Ni. The transmitting node Nj that has received the definition information 900 transmitted by the management apparatus 103 updates the definition information table 600 of the transmitting node Nj.

In the example of FIG. 9, the transmitting node Nj and the receiving node Ni create or update the record of the object types CarPosition and PersonPosition and delete the record of the object type TrainPosition.

(Example of Speed-up Message 1000)

An example of a speed-up message 1000 including a speed-up field transmitted and received by the transmitting node Nj and the receiving node Ni is described.

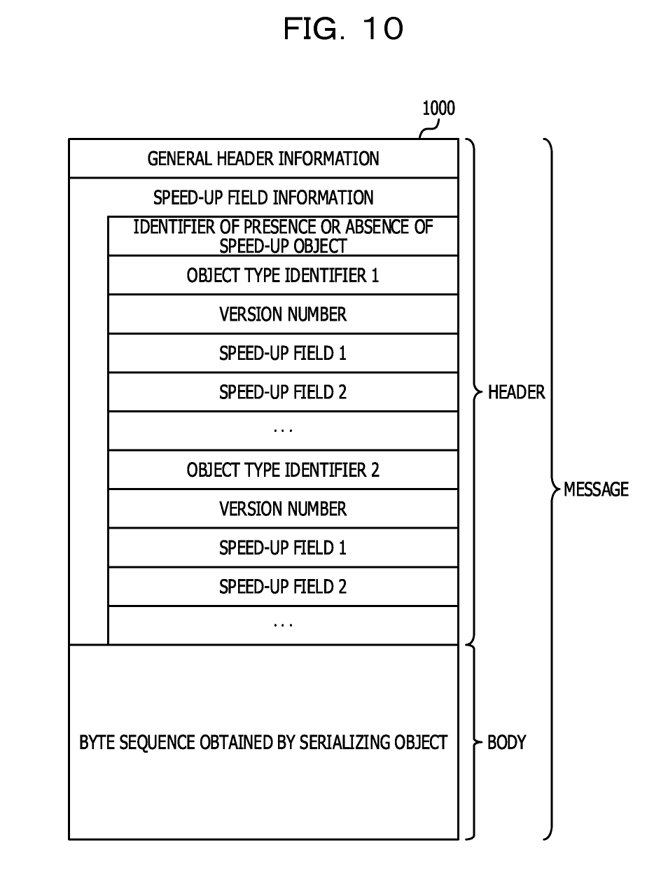

FIG. 10 illustrates an example of the speed-up message 1000 including a speed-up field transmitted and received by the transmitting node Nj and the receiving node Ni. The speed-up message 1000 including a speed-up field transmitted and received by the transmitting node Nj and the receiving node Ni is, for example, created by an embedding section 1203 of the transmitting node Nj, transmitted by the communication section 1204, and received by the communication section 1301 of the receiving node Ni.

The speed-up message 1000 including a speed-up field transmitted and received by the transmitting node Nj and the receiving node Ni has a header and a body. The header has general header information and speed-up field information. The header is stored at the start of a message. Information concerning the message is stored in the header. A data main body is stored in the body. In the general header information, important information for transmission and reception of a message such as a sender and a recipient of the message, a server via which the message is transmitted, and title is stored. For example, an IP header, a TCP header, and the like are stored in the general header information. Information concerning a speed-up field is stored in the speed-up field information.

The speed-up field information has an identifier of presence or absence of a speed-up object, an object type identifier, a version number, and a speed-up field. There can exist a plurality of object type identifiers. The version number and the speed-up field exist for each object type identifier, and therefore there can exist a plurality of version numbers and a plurality of speed-up fields. The body has a byte sequence obtained by serializing the object identified by an object type identifier of the speed-up field information.

The identifier of presence or absence of a speed-up object is an identifier indicating whether or not a message is a message including a speed-up object. The receiving node Ni can determine, based on the identifier of presence or absence of a speed-up object, whether a message is a message that includes a speed-up field or a message that does not include a speed-up field. For example, in a case where this identifier exists, the receiving node Ni can determine that a received message is a message that includes a speed-up object. In this case, the receiving node Ni can transmit a message that does not include a speed-up field in a conventional message format. This identifier may be a flag indicting whether a speed-up object exists or not.

(Example of Functional Configuration of Management Apparatus 103)

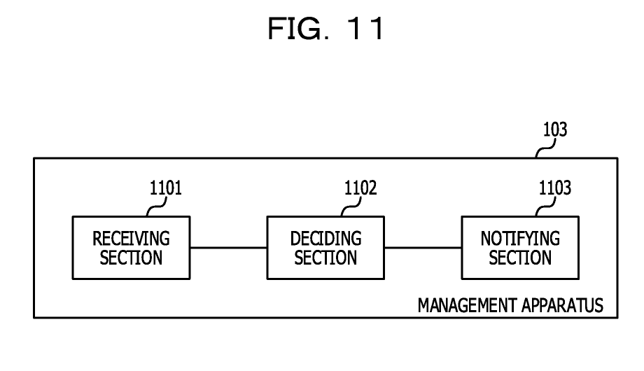

FIG. 11 illustrates an example of a functional configuration of the management apparatus 103 according to the embodiment. In FIG. 11, the management apparatus 103 includes a receiving section 1101, a deciding section 1102, and a notifying section 1103. These functional sections are realized, for example, by causing the CPU 401 to execute programs stored in a storage device such as the memory 402 illustrated in FIG. 4. Processing results of these functional sections are stored, for example, in the storage device such as the memory 402 illustrated in FIG. 4.

The receiving section 1101 has a function of receiving the statistical information 700 and 800 from the transmitting node Nj and the receiving node Ni. The receiving section 1101 delivers the received statistical information 700 and 800 to the deciding section 1102.

The deciding section 1102 has a function of deciding the definition information 900 that defines a speed-up object type and a speed-up field name based on the received statistical information 700 and 800. The deciding section 1102 delivers the decided definition information 900 to the notifying section 1103. The deciding section 1102 decides the definition information 900, for example, as follows.

The deciding section 1102, for example, calculates the product of the transmission frequency and the serialization cost for each object type based on the received statistical information 700 irrespective of a transmitting node Nj that has transmitted the statistical information 700. The transmission frequency is the number of transmissions per unit time. The transmission frequency is, for example, calculated by dividing the number of transmissions by a measurement period. The number of transmissions may be used as the transmission frequency. The deciding section 1102 decides, as speed-up object types, a predetermined number of object types in the descending order of the calculated value of the product. Alternatively, the deciding section 1102 may decide, as speed-up object types, object types whose calculated values of the product are equal to or more than a predetermined threshold value. Alternatively, the deciding section 1102 may decide speed-up object types in the descending order of the calculated value of the product until the values cover a predetermined percentage of the total sum of the calculated values of the product. The predetermined number, the predetermined threshold value, and the predetermined percentage can be decided in advance by simulation or the like and set in the management apparatus 103.

The deciding section 1102, for example, calculates the product of the reception frequency and the deserialization cost for each object type based on the received statistical information 800 irrespective of a receiving node Ni that has transmitted the statistical information 800. The reception frequency is the number of receptions per unit time. The reception frequency is calculated, for example, by dividing the number of receptions by a measurement period. The number of receptions may be used as the reception frequency. The deciding section 1102 can decide speed-up object types in the same manner as the received statistical information 700. The deciding section 1102 may decide a speed-up field name by extracting a field name whose reference frequency is equal to or more than a predetermined threshold value among the speed-up object types decided based on the statistical information 800. This predetermined threshold value can also be decided in advance by simulation or the like and set in the management apparatus 103.

Furthermore, the deciding section 1102 can decide the definition information 900 as follows. The deciding section 1102 selects, from the received statistical information 700, statistical information 700 received from a transmitting node Nj whose CPU load is highest among transmitting nodes Nj that have transmitted the statistical information 700. The deciding section 1102 calculates the product of the transmission frequency and the serialization cost for each object type based on the selected statistical information 700. The deciding section 1102 decides, as speed-up object type, a predetermined number of object types in the descending order of the calculated values of the product. Alternatively, the deciding section 1102 may decide, as speed-up object types, object types whose calculated values of the product are equal to or more than a predetermined threshold value. Alternatively, the deciding section 1102 may decide speed-up object types in the descending order of the calculated value of the product until the values cover a predetermined percentage of the total sum of the calculated values of the product. The predetermined number, the predetermined threshold value, and the predetermined percentage can be decided in advance by simulation or the like and set in the management apparatus 103.

The deciding section 1102 selects, from the received statistical information 800, statistical information 800 received from a receiving node Ni whose CPU load is highest among receiving nodes Ni that have received the statistical information 800. The deciding section 1102 calculates the product of the reception frequency and the deserialization cost for each object type based on the selected statistical information 800. The deciding section 1102 can decide speed-up object types in the same manner as the received statistical information 700. Furthermore, the deciding section 1102 can also decide a speed-up field name by extracting a field name whose reference frequency is equal to or more than a predetermined threshold value among the speed-up object types decided based on the statistical information 800. This predetermined threshold value can also be decided in advance by simulation or the like and set in the management apparatus 103.

Alternatively, the deciding section 1102 may decide, as speed-up object types, a predetermined number of object types in the descending order of the product of the reception frequency and the deserialization cost and the product of the transmission frequency and the serialization cost without distinguishing the receiving node Ni and the transmitting node Nj. Alternatively, the deciding section 1102 may decide, as speed-up object types, object types whose calculated values of the product are equal to or more than a predetermined threshold value without distinguishing the receiving node Ni and the transmitting node Nj. Alternatively, the deciding section 1102 may decide speed-up object types in the descending order of the calculated values of the product until the values cover a predetermined percentage of the total sum of the calculated values of the product without distinguishing the receiving node Ni and the transmitting node Nj.

The deciding section 1102 registers the decided speed-up object types in the definition information 900 and defines version numbers. In a case where the decided speed-up object types are already registered in the definition information 900, the deciding section 1102 defines new version numbers. In this case, the deciding section 1102, for example, increases the version numbers.

The deciding section 1102 decides, for each speed-up object type, the position and the format of a field identified by the field name in a message and register the position and the format in the definition information 900.

The deciding section 1102 may store, in the storage device, the statistical information 800 received from the receiving node Ni and the statistical information 700 received from the transmitting node Nj. In this case, in a case where the deciding section 1102 receives the statistical information 800 and the statistical information 700, the deciding section 1102 updates the statistical information stored in the storage device. The deciding section 1102 may also decide a speed-up object type and a speed-up field name based on the statistical information stored in the storage device.

The deciding section 1102 may also decide a speed-up object type and a speed-up field name not based on both of the statistical information 800 received from the receiving node Ni and the statistical information 700 received from the transmitting node Nj but based on one of the statistical information 800 and the statistical information 700. For example, in a case where it is clear that only the receiving node Ni is a bottleneck, the deciding section 1102 may decide a speed-up object type and a speed-up field name based on the statistical information 800 received from the receiving node Ni.

If all of the transmitting nodes Nj have the same capability, different object types have the same serialization cost. In such a case, the serialization cost of the object types may be stored as a separate table that is separate from the statistical information 700. Similarly, in a case where all of the receiving nodes Ni have the same capability, different object types have the same deserialization cost. In such a case, the deserialization cost of the object types may be stored as a separate table that is separate from the statistical information 800. In these cases, it is unnecessary to calculate the serialization costs and the deserialization costs of the transmitting nodes Nj and the receiving nodes Ni and transmit the serialization costs and the deserialization costs to the management apparatus 103.

The notifying section 1103 has a function of notifying the transmitting node Nj and the receiving node Ni of the definition information 900.

(Example of Functional Configuration of Transmitting Node Nj)

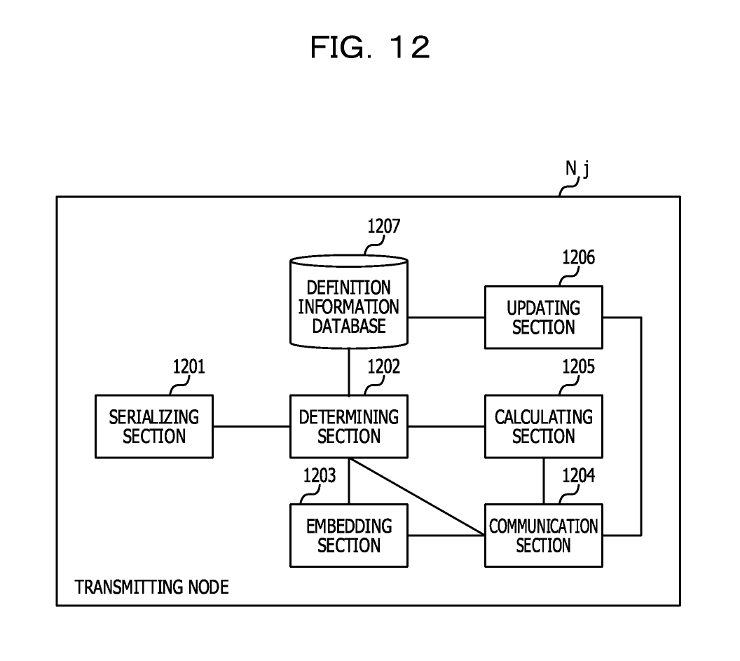

FIG. 12 illustrates an example of a functional configuration of the transmitting node Nj according to the embodiment. In FIG. 12, the transmitting node Nj includes a serializing section 1201, a determining section 1202, the embedding section 1203, the communication section 1204, the calculating section 1205, the updating section 1206, and a definition information database 1207. These functional sections are realized, for example, by causing the CPU 401 to execute programs stored in the storage device such as the memory 402 illustrated in FIG. 4. Processing results of these functional sections are stored, for example, in the storage device such as the memory 402 illustrated in FIG. 4.

The serializing section 1201 has a function of converting a transmitted object to a serialized byte sequence. The serializing section 1201 delivers the converted byte sequence to the determining section 1202.

The determining section 1202 has a function of determining whether or not an object type for identifying a transmitted object is registered in the definition information 900. In a case where the object type is registered in the definition information 900, the determining section 1202 notifies the embedding section 1203 that the object type is registered, and delivers the byte sequence supplied from the determining section 1202 to the embedding section 1203. In a case where the object type is not registered in the definition information 900, the determining section 1202 creates a message including the byte sequence supplied from the serializing section 1201, and then delivers the created message to the communication section 1204.

The embedding section 1203 embeds a speed-up field in the message in accordance with a position and a format described in the definition information 900, and then creates a speed-up message 1000 including the object type and the byte sequence delivered by the serializing section 1201. The embedding section 1203 delivers the created speed-up message 1000 to the communication section 1204.

The communication section 1204 has a function of transmitting, to the receiving node Ni, the message delivered from the determining section 1202 and the speed-up message 1000 delivered from the embedding section 1203. Furthermore, the communication section 1204 has a function of transmitting the statistical information 700 calculated by the calculating section 1205 to the management apparatus 103. Furthermore, the communication section 1204 has a function of receiving the definition information 900 transmitted by the management apparatus 103. The communication section 1204 delivers the received definition information 900 to the updating section 1206.

The communication section 1204 may transmit the statistical information 700 calculated by the calculating section 1205 to the management apparatus 103 every certain period. Alternatively, the communication section 1204 may transmit the statistical information 700 to the management apparatus 103 when the contents of the statistical information 700 are markedly different from the previously transmitted contents. For example, the communication section 1204 transmits the statistical information 700 to the management apparatus 103 when the order of the values of the product of the transmission frequency and the serialization cost has changed. In a case where the management apparatus 103 both collects the other statistical information and manages the receiving node Ni and the transmitting node Nj, the communication section 1204 may transmit the statistical information 700 to the management apparatus 103 together with the other statistical information and management information. Alternatively, the communication section 1204 may transmit the statistical information 700 to the management apparatus 103 when the load on the transmitting node Nj becomes high. The transmitting node Nj can request the management apparatus 103 for optimization of the load in the sense of an emergency request. The management apparatus 103 decides the speed-up object type and the speed-up field name again in order to optimize the load upon notification of the high load. Alternatively, the communication section 1204 may transmit the statistical information 700 to the management apparatus 103 at a timing requested by the management apparatus 103. For example, in a case where optimization of the load is requested by the receiving node Ni or the transmitting node Nj, the management apparatus 103 requests all of the receiving nodes Ni or transmitting nodes Nj for the statistical information 700 or 800. The management apparatus 103 decides the speed-up object type and the speed-up field name again based on the statistical information 700 or 800 received in response to the request.

The calculating section 1205 has a function of calculating the statistical information 700. The calculating section 1205 delivers the calculated statistical information 700 to the communication section 1204. The updating section 1206 has a function of updating the definition information table 600 stored in the definition information database 1207 based on the definition information 900 delivered by the communication section 1204. The updating section 1206 acquires an object type and a version number from the definition information 900. In a case where field name, position, and format are null, the updating section 1206 deletes the object type from the definition information table 600. In a case where the field name, position, and format are not null, the updating section 1206 updates the definition information table 600 with the object type.

(Example of Functional Configuration of Receiving Node Ni)

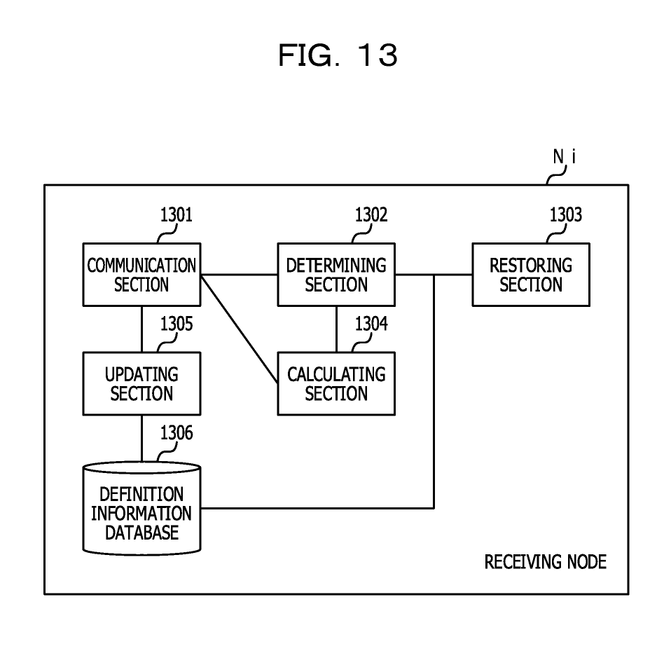

FIG. 13 illustrates an example of a functional configuration of the receiving node Ni according to the embodiment. In FIG. 13, the receiving node Ni includes the communication section 1301, the determining section 1302, a restoring section 1303, the calculating section 1304, the updating section 1305, and a definition information database 1306. These functional sections are realized, for example, by causing the CPU 401 to execute programs stored in the storage device such as the memory 402 illustrated in FIG. 4. Processing results of these functional sections are stored, for example, in the storage device such as the memory 402 illustrated in FIG. 4.

The communication section 1301 has a function of receiving a message transmitted from the transmitting node Nj. The communication section 1301 delivers the received message to the determining section 1302. Furthermore, the communication section 1301 has a function of transmitting the statistical information 800 calculated by the calculating section 1304 to the management apparatus 103. Furthermore, the communication section 1301 has a function of receiving the definition information 900 transmitted by the management apparatus 103. The communication section 1301 delivers the received definition information 900 to the updating section 1305.

The communication section 1301 may transmit the calculated statistical information 800 to the management apparatus 103 at the same timing as the communication section 1204 of the transmitting node Nj.

The determining section 1302 has a function of determining whether or not a predetermined condition is satisfied in a case where the message delivered by the communication section 1301 is a speed-up message 1000. Furthermore, the determining section 1302 has a function of delivering the message to the restoring section 1303 in a case where the message delivered by the communication section 1301 is not a speed-up message 1000.

The determining section 1302 determines whether or not the message delivered by the communication section 1301 is a speed-up message 1000, for example, based on an identifier indicative of presence or absence of a speed-up object. In a case where the determining section 1302 determines that the message is a speed-up message 1000, the determining section 1302 acquires an object type and a version number from the speed-up message 1000. The determining section 1302 determines whether or not the acquired object type and version number are defined in the definition information table 500. In a case where the determining section 1302 determines that the acquired object type is an object type defined in the definition information table 500, the determining section 1302 extracts a value of a speed-up field based on a position and a format that are defined in association with the object type in the definition information table 500. The determining section 1302 determines whether or not the extracted value satisfies the condition of the definition information table 500. In a case where the determining section 1302 determines that the extracted value does not satisfy the condition, the determining section 1302 discards the speed-up message 1000. In a case where the determining section 1302 determines that the extracted value satisfies the condition, the determining section 1302 determines whether or not a value of another speed-up field of the definition information table 500 that is related to the object type satisfies the condition. In a case where the determining section 1302 determines that at least one of the values of all of the speed-up fields related to the object type does not satisfy the condition, the determining section 1302 discards the speed-up message 1000. In a case where the values of all of the speed-up fields satisfy the condition, the determining section 1302 performs similar determination as to another speed-up object of the speed-up message 1000. In a case where the values of the speed-up fields of all of the speed-up objects of the speed-up message 1000 satisfy the condition, the determining section 1302 delivers the speed-up message 1000 to the restoring section 1303.

The restoring section 1303 has a function of restoring an object from a byte sequence of the message delivered by the determining section 1302 and a byte sequence of the speed-up message 1000. For example, the restoring section 1303 delivers the restored object to a program that performs processing such as analysis in the receiving node Ni.

The calculating section 1304 has a function of calculating the statistical information 800. The calculating section 1304 delivers the calculated statistical information 800 to the communication section 1301.

The updating section 1305 has a function of updating the definition information table 500 stored in the definition information database 1306 based on the definition information 900 delivered by the communication section 1301. The updating section 1305 acquires an object type and a version number from the definition information 900. In a case where the field name, position, and format are null, the updating section 1305 deletes the object type from the definition information table 500. In a case where the field name, position, and format are not null, the updating section 1305 registers the object type in the definition information table 500.

(Data Processing of Receiving Node Ni)

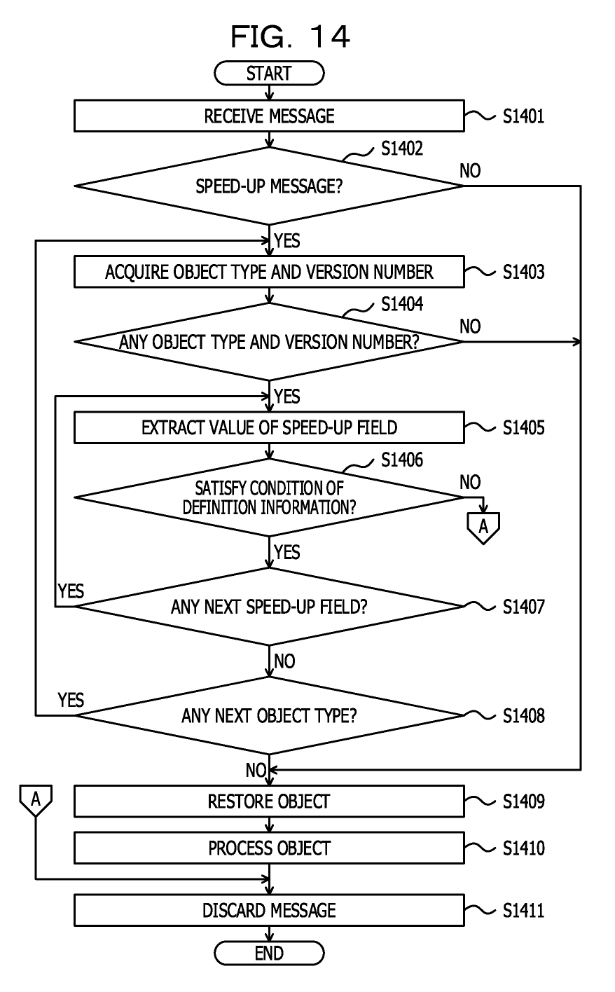

FIG. 14 is a flow chart illustrating an example of a procedure of data receiving processing of the receiving node Ni according to the embodiment. In the flow chart of FIG. 14, first, the communication section 1301 receives a message transmitted from the transmitting node Nj (Step S1401). Next, the determining section 1302 determines whether or not the received message is a speed-up message 1000 (Step S1402).

In a case where the received message is a speed-up message 1000 (Yes in Step S1402), the determining section 1302 acquires an object type and a version number from the speed-up message 1000 (Step S1403). Next, the determining section 1302 determines whether or not the acquired object type and version number are defined in the definition information table 500 (Step S1404). In a case where the acquired object type and version number are defined in the definition information table 500 (Yes in Step S1404), the determining section 1302 extracts a value of a speed-up field based on a position and a format defined in the definition information table 500 (Step S1405). The determining section 1302 determines whether or not the extracted value satisfies the condition of the definition information table 500 (Step S1406). In a case where the extracted value does not satisfy the condition of the definition information table 500 (No in Step S1406), the determining section 1302 discards the received message (Step S1411).

In a case where the extracted value satisfies the condition of the definition information table 500 (Yes in Step S1406), the determining section 1302 determines whether or not there is a next speed-up field (Step S1407). In a case where there is a next speed-up field (Yes in Step S1407), the processing proceeds to Step S1405, in which the determining section 1302 performs processing with respect to the next speed-up field. In a case where there is no next speed-up field (No in Step S1407), the determining section 1302 determines whether or not there is a next object type (Step S1408). In a case where there is a next object type (Yes in Step S1408), the processing proceeds to Step S1403, in which the determining section 1302 performs processing with respect to the next object type.

In a case where there is no next object type (No in Step S1408), the restoring section 1303 restores the object from the byte sequence of the received message (Step S1409). In a case where the received message is not a speed-up message 1000 (No in Step S1402) and in a case where the acquired object type and version number are not defined in the definition information table 500 (No in Step S1404), the restoring section 1303 performs similar processing.

Then, processing such as analysis is performed with respect to the object restored by the receiving node Ni (Step S1410). The receiving node Ni discards the received message after finishing the processing such as analysis (Step S1411). Thus, the series of processing according to this flow chart is finished. By executing this flow chart, in a case where the message received by the receiving node Ni is a speed-up message 1000, the receiving node Ni can determine whether or not a value of a field of the object satisfies the condition without restoring the object.

(Data Processing of Transmitting Node Nj)

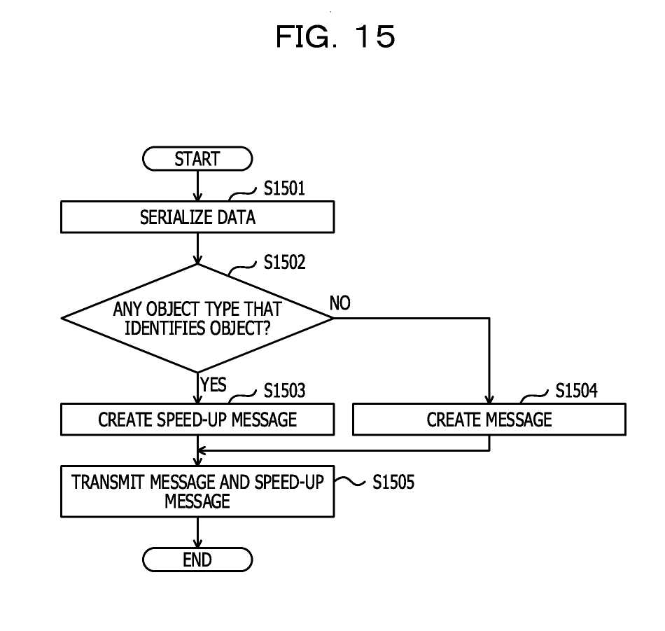

FIG. 15 is a flow chart illustrating an example of a procedure of data transmitting processing of the transmitting node Nj according to the embodiment. In the flow chart of FIG. 15, first, the serializing section 1201 converts an object to be transmitted to a serialized byte sequence (Step S1501). Next, the determining section 1202 determines whether or not an object type for identifying the object to be transmitted is registered in the definition information 900 (Step S1502).

In a case where the object type is registered in the definition information 900 (Yes in Step S1502), the embedding section 1203 embeds a speed-up field in a message in accordance with a position and a format that are described in association with the object type in the definition information 900, and then creates a speed-up message 1000 that includes the object type and the byte sequence delivered by the serializing section 1201 (Step S1503). Then, the processing proceeds to Step S1505.

In a case where the object type is not registered in the definition information 900 (No in Step S1502), the determining section 1202 creates a message that includes the byte sequence delivered by the serializing section 1201 (Step S1504).

The communication section 1204 transmits the created message or speed-up message 1000 to the receiving node Ni (Step S1505). Thus, the series of processing according to this flow chart is finished. By executing this flow chart, in a case where the object type of the object transmitted by the transmitting node Nj is registered in the definition information 900, the speed-up message 1000 is created and transmitted to the receiving node Ni.

(Definition Information Table 500 Updating Processing of Receiving Node Ni)

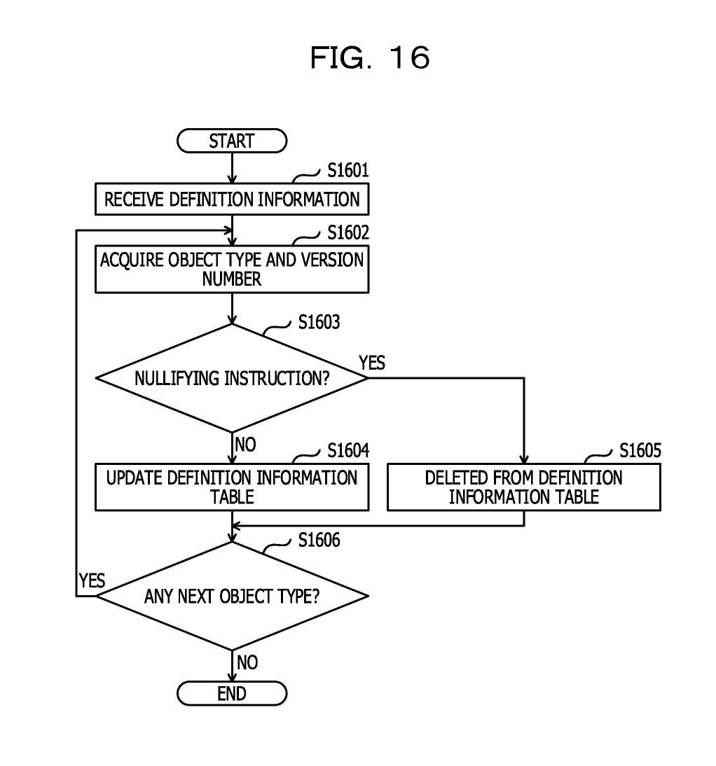

FIG. 16 is a flow chart illustrating an example of a procedure of definition information table 500 updating processing of the receiving node Ni according to the embodiment. In the flow chart of FIG. 16, first, the communication section 1301 receives the definition information 900 transmitted by the management apparatus 103 (Step S1601). Next, the updating section 1305 acquires an object type and a version number from the definition information 900 (Step S1602). The updating section 1305 determines whether or not the record of the acquired object type and version number is a nullifying instruction, that is, the field name, position, and format are null (Step S1603).

In a case where the field name, position, and format are not null (No in Step S1603), the updating section 1305 updates the definition information table 500 by using the object type, version number, field name, positon, and format (Step S1604). Then, the processing proceeds to Step S1606. In a case where the field name, position, and format are null (Yes in Step S1603), the updating section 1305 deletes the object type from the definition information table 500 (Step S1605).

The updating section 1305 determines whether or not there is a next object type in the definition information 900 (Step S1606). In a case where there is a next object type (Yes in Step S1606), the updating section 1305 returns to Step S1602, in which the updating section 1305 performs next processing with respect to the object type. In a case where there is no next object type (No in Step S1606), the updating section 1305 finishes processing. Thus, the series of processing according to this flow chart is finished. By executing this flow chart, the definition information table 500 of the receiving node Ni is updated.

Definition information table 600 updating processing of the transmitting node Nj can be performed by a similar procedure to the definition information table 500 updating processing of the receiving node Ni.

(Speed-Up Object Deciding Processing of Management Apparatus 103)

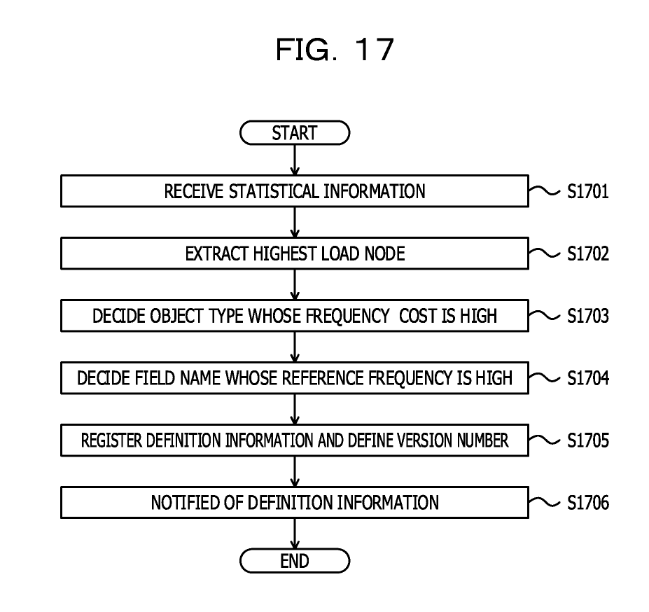

FIG. 17 is a flow chart illustrating an example of a procedure of speed-up object deciding processing of the management apparatus 103 according to the embodiment. The flow chart illustrated in FIG. 17 is a flow chart of a case where the management apparatus 103 receives the statistical information 800 from the receiving node Ni. In the flow chart of FIG. 17, first, the receiving section 1101 receives the statistical information 800 from the receiving node Ni (Step S1701).

Next, the deciding section 1102 extracts, from the received statistical information 800, statistical information 800 received from a receiving node Ni whose CPU load is highest among the receiving nodes Ni that transmitted the statistical information 800 (Step S1702). The deciding section 1102 calculates the product of the reception frequency and the deserialization cost for each object type based on the extracted statistical information 800, and determines, as speed-up object types, a predetermined number of object types in the descending order of the calculated values of the product (Step S1703).

The deciding section 1102 determines a speed-up field name by extracting a field name whose reference frequency is high among the speed-up object types determined based on the statistical information 800 (Step S1704). The deciding section 1102 registers, in the definition information 900, the determined speed-up object types and speed-up field name and defines version numbers (Step S1705). The notifying section 1103 notifies the transmitting node Nj and the receiving node Ni of the definition information 900 (Step S1706). Thus, the series of processing according to this flow chart is finished. By executing this flow chart, the management apparatus 103 determines a speed-up object.

Speed-up object deciding processing performed in a case where the management apparatus 103 receives the statistical information 700 from the transmitting node Nj can be performed in a similar manner to that performed in a case where the management apparatus 103 receives the statistical information 800 from the receiving node Ni.

(Statistical Information 800 Calculating Processing of Receiving Node Ni)

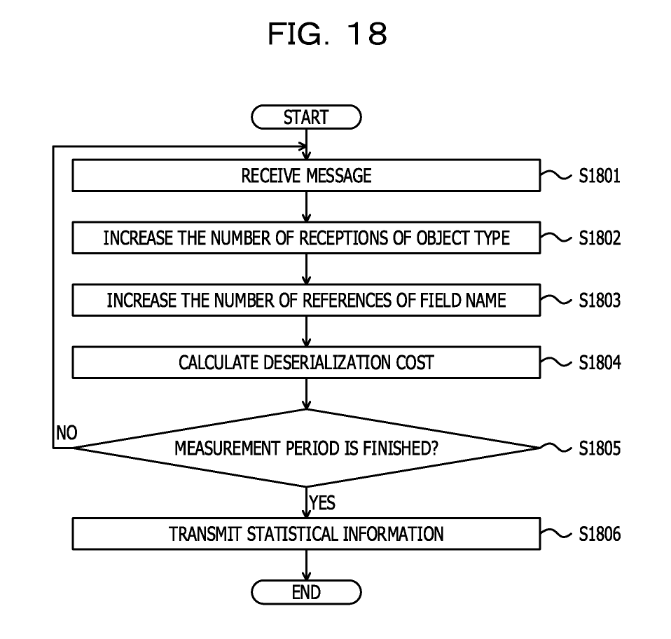

FIG. 18 is a flow chart illustrating an example of a procedure of statistical information 800 calculating processing of the receiving node Ni according to the embodiment. In the flow chart of FIG. 18, first, the communication section 1301 receives a message from the transmitting node Nj (Step S1801).

Next, the calculating section 1304 increases the number of receptions of an object type in the statistical information 800 that corresponds to an object type included in the message (Step S1802). The calculating section 1304 increases the number of references of a field name in the statistical information 800 that corresponds to a field name of the object type referred to by the determining section 1302 (Step S1803). The calculating section 1304 calculates a deserialization cost of the object type included in the message (Step S1804).

The calculating section 1304 determines whether or not a measurement period has been finished (Step S1805). In a case where the measurement period has not been finished (No in Step S1805), the processing returns to Step S1801, in which a next message is processed. In a case where the measurement period has been finished (Yes in Step S1805), the communication section 1301 transmits the statistical information 800 to the management apparatus 103 (Step S1806). Thus, the series of processing according to this flow chart is finished. By executing this flow chart, the receiving node Ni calculates the statistical information 800 and transmits the statistical information 800 to the management apparatus 103.

Calculation of the statistical information 700 and transmission of the statistical information 700 to the management apparatus 103 by the transmitting node Nj can be performed by a similar procedure to the procedure of the statistical information 800 calculating processing the receiving node Ni.

(First Example of Speed-Up Object Deciding Processing)

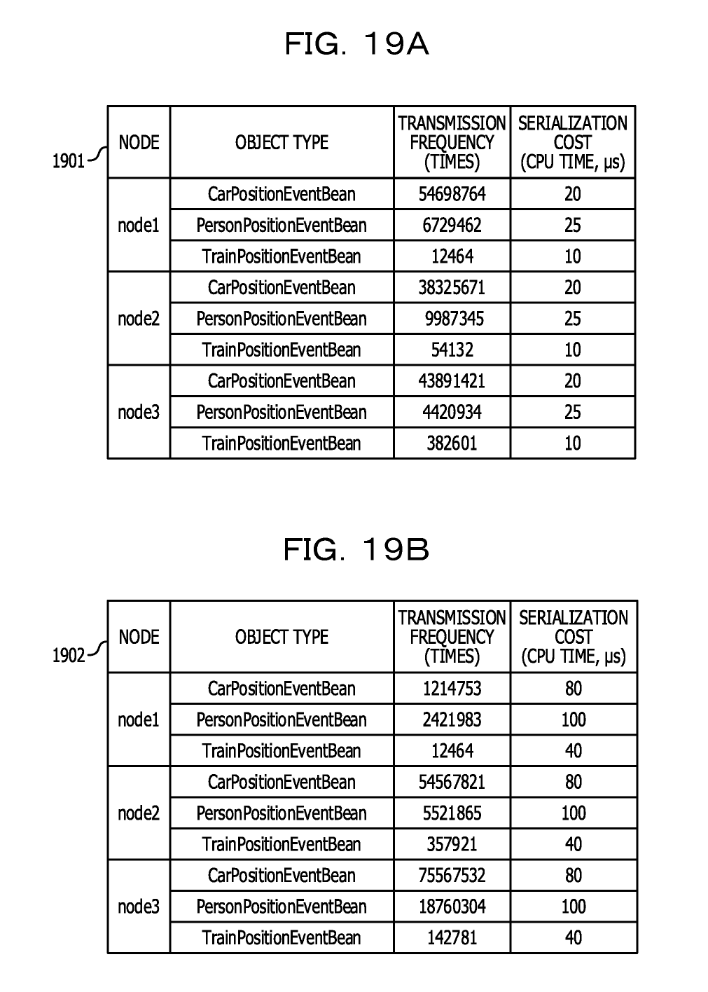

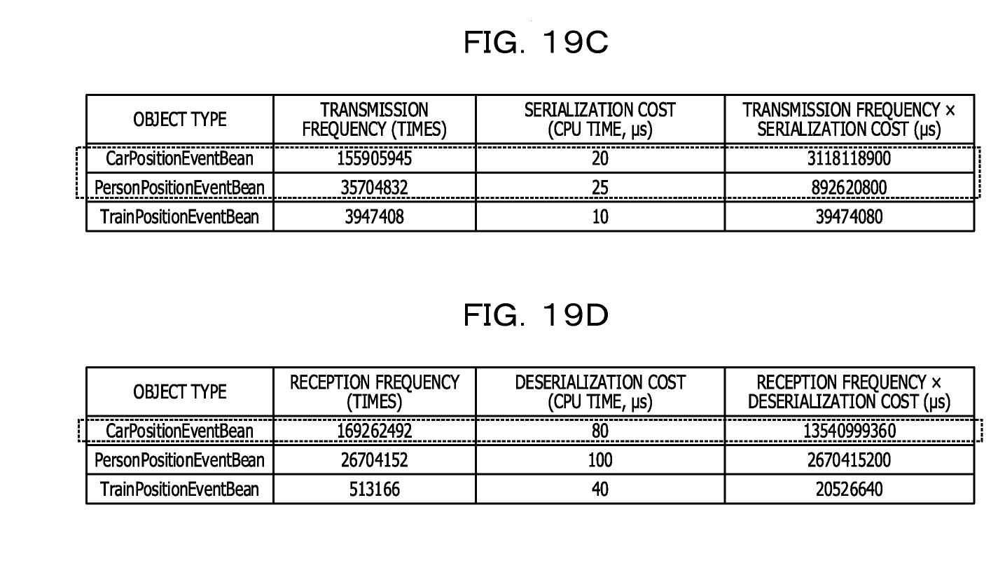

FIGS. 19A, 19B, 19C, and 19D illustrate a first example of the speed-up object deciding processing of the management apparatus 103 according to the embodiment.

FIG. 19A illustrates an example of part of statistical information 1901 received from the transmitting node Nj by the management apparatus 103. FIG. 19B illustrates an example of part of statistical information 1902 received from the receiving node Ni by the management apparatus 103. FIGS. 19A and 19B illustrate part of the received statistical information 1901 and part of the received statistical information 1902, respectively, each of which also includes statistical information of a node other than nodes 1 to 3 illustrated in FIGS. 19A and 19B. In FIG. 19A, the number of transmissions is used as the transmission frequency, and a CPU time taken for serialization is used as the serialization cost. In FIG. 19B, the number of receptions is used as the reception frequency, and a CPU time taken to deserialize and generate an object is used as the deserialization cost.

The deciding section 1102 calculates the product of the transmission frequency and the serialization cost for each object type based on the statistical information 1901, and arranges the calculated values of the product in the descending order. FIG. 19C is a table illustrating top three object types in terms of the product of the transmission frequency and the serialization cost.

The deciding section 1102 calculates the product of the reception frequency and the deserialization cost for each object type based on the statistical information 1902, and arranges the calculated values of the product in the descending order. FIG. 19D is a table illustrating top three object types in terms of the product of the reception frequency and the deserialization cost.

The deciding section 1102 determines, as speed-up object types, top three object types in terms of the calculated product without distinguishing the receiving node Ni and the transmitting node Nj. In the example of FIG. 19C, CarPositionEventBean and PersonPositionEventBean are determined as speed-up object types. In the example of FIG. 19D, CarPositionEventBean is determined as a speed-up object type.

(Second Example of Speed-Up Object Deciding Processing)

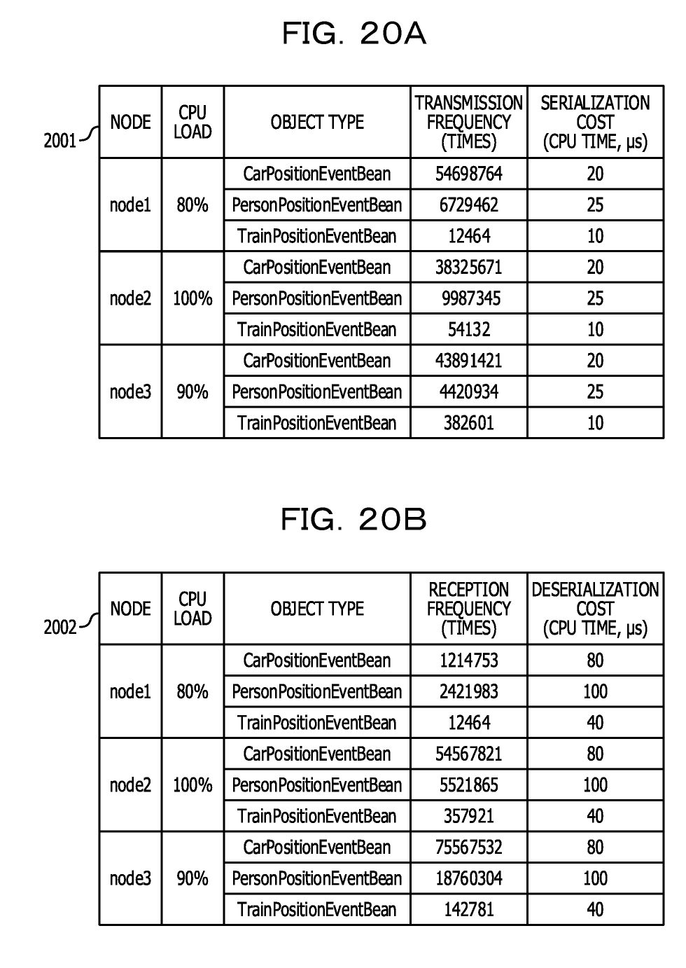

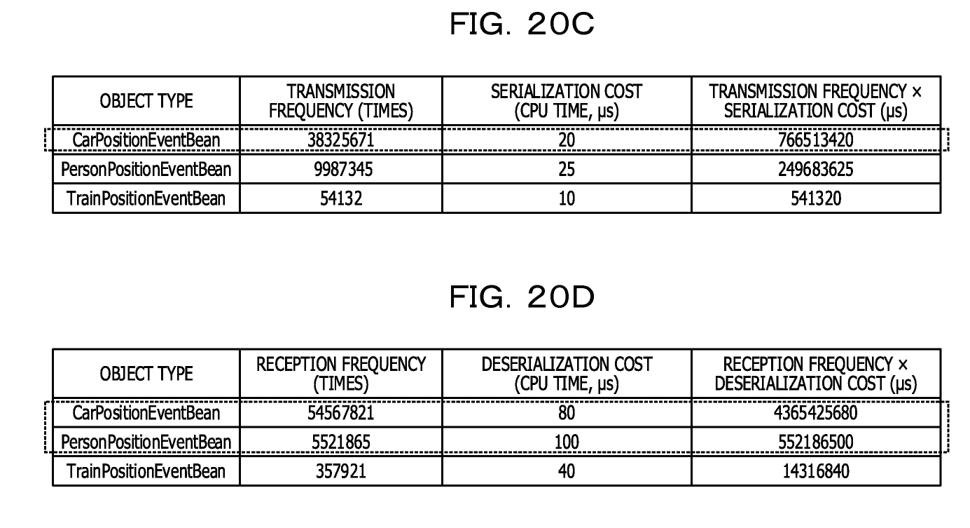

FIGS. 20A, 20B, 20C, and 20D illustrate a second example of the speed-up object deciding processing of the management apparatus 103 according to the embodiment.

FIG. 20A illustrates an example of part of statistical information 2001 received from the transmitting node Nj by the management apparatus 103. FIG. 20B illustrates an example of part of statistical information 2002 received from the receiving node Ni by the management apparatus 103. FIGS. 20A and 20B illustrate part of the received statistical information 2001 and part of the received statistical information 2002, respectively, each of which also includes statistical information of a node other than nodes 1 to 3 illustrated in FIGS. 20A and 20B. In FIG. 20A, the number of transmissions is used as the transmission frequency, and a CPU time taken for serialization is used as the serialization cost. In FIG. 20B, the number of receptions is used as the reception frequency, and a CPU time taken to deserialize and generate an object is used as the deserialization cost.

The deciding section 1102 extracts the node 2 whose CPU load is highest from the statistical information 2001, calculates, for each object type, the product of the transmission frequency and the serialization cost, and then arranges the calculated values of the product in the descending order. FIG. 20C is a table illustrating top three object types in terms of the product of the transmission frequency and the serialization cost of the node 2.

The deciding section 1102 extracts the node 2 whose CPU load is highest from the statistical information 2002, calculates, for each object type, the product of the reception frequency and the deserialization cost, and arranges the calculated values of the product in the descending order. FIG. 20D is a table illustrating top three object types in terms of the product of the reception frequency and the deserialization cost of the node 2.

The deciding section 1102 decides, as speed-up object types, top three object types in terms of the calculated product without distinguishing the receiving node Ni and the transmitting node Nj. In the example of FIG. 20C, CarPositionEventBean is determined as a speed-up object type. In the example of FIG. 20D, CarPositionEventBean and PersonPositionEventBean are determined as speed-up object types.

As described above, according to the receiving node Ni according to the present embodiment, in a case where an identifier included in a received message is stored in the definition information table 500, it is determined whether or not information in a predetermined region of the message satisfies the condition of the definition information table 500 that is associated with the identifier, and the received message can be restored in accordance with the result of the determination. This makes it unnecessary for the receiving node Ni to generate an object through deserialization in a case where the data is one that does not include a value used for analysis processing or the like and that is therefore discarded even if the object is generated through deserialization. It becomes therefore unnecessary to perform unnecessary generation of an object through deserialization.

In the processing system 100, the management apparatus 103 that is independent of the receiving node Ni and the transmitting node Nj manages the processing system 100. This allows the management apparatus 103 to decide a speed-up object type and a speed-up field name for each connection by utilizing the statistical information 700 and 800 transmitted and received among a plurality of communication connections. Since the management apparatus 103 manages the processing system 100, a speed-up object type and a speed-up field name that are common to the whole processing system 100 can be decided.

The management apparatus 103 can decide a speed-up object type and a speed-up field name based on the statistical information 700 and 800 received from the transmitting node Nj and the receiving node Ni. This makes it possible to decide the speed-up object type and the speed-up field name based on actual communication contents and to reduce a CPU's processing cost of the receiving node Ni desired for generation an object through deserialization.

The management apparatus 103 can decide a speed-up object type and a speed-up field name in the descending order of the product of the reception frequency of the statistical information 700 and 800 received from the receiving node Ni and the deserialization cost. This makes it unnecessary to generate an object through deserialization as for object types and field names that increase the load of the receiving node Ni, thereby making it possible to reduce a CPU's processing cost of the receiving node Ni desired for generation of an object through deserialization.

Next, a processing method according to another embodiment is described. In this embodiment, at least one of nodes N1 to Nn (n is a natural number of 2 or more) has a function of a receiving-side node that receives data and the function of the management apparatus 103 of the above embodiment. As in the above embodiment, a receiving-side node that receives data is sometimes referred to as a “receiving node Ni”, and a transmitting-side node that transmits data is sometimes referred to as a “transmitting node Nj”. Note that parts that are identical to those described in the above embodiment are not illustrated nor described.

(Example of System Configuration of Processing System 2100)

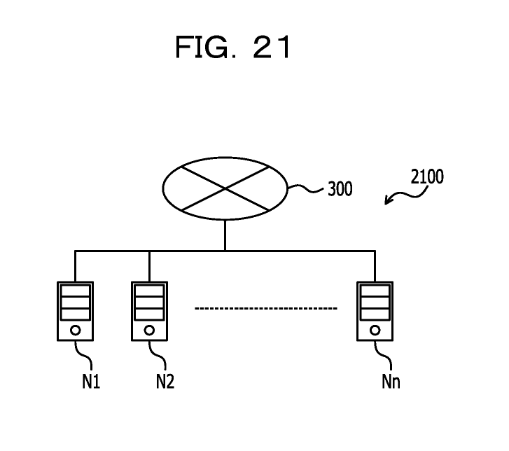

FIG. 21 illustrates an example of a system configuration of a processing system 2100 according to another embodiment. In FIG. 21, the processing system 2100 has nodes N1 to Nn. The nodes N1 to Nn are coupled to each other via a wired or wireless network 300. In FIG. 21, the node Nn has a function of a receiving node Ni and the function of the management apparatus 103 of the above embodiment.

(Example of Functional Configuration of Node Nn)

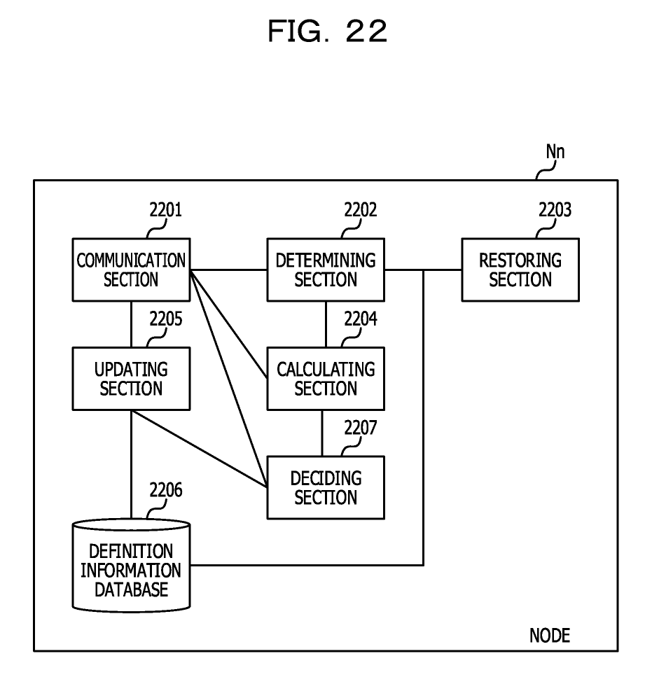

FIG. 22 illustrates an example of a functional configuration of a node Nn according to the embodiment. In FIG. 22, the node Nn includes a communication section 2201, a determining section 2202, a restoring section 2203, a calculating section 2204, an updating section 2205, a definition information database 2206, and a deciding section 2207. These functional sections are realized, for example, by causing a CPU 401 to execute programs stored in a storage device such as the memory 402 illustrated in FIG. 4. Processing results of these functional sections are stored, for example, in the storage device such as the memory 402 illustrated in FIG. 4.

The communication section 2201 has a function of receiving a message transmitted from the transmitting node Nj. The communication section 2201 delivers the received message to the determining section 2202. The communication section 2201 has a function of receiving statistical information 700 from the transmitting node Nj. The communication section 2201 delivers the received statistical information 700 to the deciding section 2207. The communication section 2201 has a function of notifying the transmitting node Nj of definition information 900 decided by the deciding section 2207.

The determining section 2202, the restoring section 2203, and the updating section 2205 have the same functions as the determining section 1302, the restoring section 1303, and the updating section 1305 of the above embodiment, respectively.

The calculating section 2204 has a function of calculating statistical information 800. The calculating section 2204 delivers the calculated statistical information 800 to the deciding section 2207.

The deciding section 2207 has the same function as the deciding section 1102 of the management apparatus 103 of the above embodiment. The deciding section 2207 delivers the decided definition information 900 to the communication section 2201.

Note that a procedure of data receiving processing of the node Nn according to this embodiment is similar to the procedure of the data receiving processing of the receiving node Ni according to the above embodiment, and are therefore not illustrated nor described. A procedure of definition information table 500 updating processing of the node Nn according to this embodiment is similar to the procedure of the definition information table 500 updating processing of the receiving node Ni according to the above embodiment, and are therefore not illustrated nor described. A procedure of speed-up object deciding processing of the receiving node Nn according to this embodiment is similar to the procedure of the speed-up object deciding processing of the management apparatus 103 according to the above embodiment, and are therefore not illustrated nor described. A procedure of statistical information 800 calculating processing of the node Nn according to this embodiment is similar to the procedure of the statistical information 800 calculating processing of the receiving node Ni according to the above embodiment, and are therefore not illustrated nor described.

As described above, in the processing system 2100 according to this embodiment, the node Nn has both a receiving function and a managing function. This allows the node Nn to decide a speed-up object type and a speed-up field name for each connection of communication between the transmitting node Nj and the receiving node Ni. Furthermore, since the node Nn calculates the statistical information 800, the speed-up object type and the speed-up field name can be decided only by the node Nn.

Processing programs described in the present embodiment can be realized by causing a computer such as a personal computer or a work station to execute programs prepared in advance. The processing programs are stored in a computer-readable storage medium such as a hard disc, a flexible disc, a CD-ROM, an MO, or a DVD and executed by causing the computer to read out the processing programs from the storage medium. The processing programs may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of processing data, comprising:
storing definition information in which a first identifier for identifying a type of data and a condition for executing predetermined processing are associated with each other;
receiving the data;
first determining whether or not information in a predetermined region of the received data satisfies the condition associated with the first identifier in the definition information in a case where a second identifier included in the received data matches the first identifier in the definition information; and
second determining, based on the first determining, that the received data is restored.

2. The method according to claim 1, further comprising:
deciding a first type among a plurality of types based on a reception frequency of data and a processing time taken for restoration of the data that are obtained for each of the plurality of types; and
registering, in the definition information, a third identifier for identifying the decided first type and a condition for executing predetermined processing in such a manner that the third identifier and the condition are associated with each other.

3. The method according to claim 2, wherein the deciding decides the first type based on a product of the reception frequency of data and the processing time taken for restoration of the data that are obtained for each of the plurality of types.

4. The method according to claim 3, wherein the deciding decides a predetermined number of first types that correspond to the products obtained for the plurality of types in a descending order of values of the products.

5. The method according to claim 3, wherein the deciding decides the first type that corresponds to a product whose value is equal to or more than a threshold value among the products obtained for the plurality of types.

6. The method according to claim 1, further comprising:
deciding a second type among a plurality of types based on a transmission frequency of data and a processing time taken for encoding the data that are obtained for each of the plurality of types; and
registering, in the definition information, a fourth identifier for identifying the decided second type and a condition for executing the predetermined processing in such a manner that the fourth identifier and the condition are associated with each other.

7. The method according to claim 1, further comprising:
transmitting, to a computer, a reception frequency of data and a processing time taken for restoration of the data that are obtained for each of a plurality of types;
deciding, by the computer, a third type among the plurality of types based on the reception frequency of data and the processing time taken for restoration of the data that are obtained for each of the plurality of types;
receiving a fifth identifier for identifying the third type from the computer; and
registering, in the definition information, the received fifth identifier and a condition for executing the predetermined processing in such a manner that the fifth identifier and the condition are associated with each other.

8. The method according to claim 1, wherein:
the definition information includes an item of the data that is identified by an item name associated with the first identifier and the condition for executing the predetermined processing, and
the first determining determines whether or not the information in the predetermined region of the received data satisfies the condition associated with the item of the data associated with the first identifier in the definition information in a case where the second identifier included in the received data matches the first identifier stored in the definition information.

9. The method according to claim 1, further comprising:
deciding a first item name among item names that correspond to a plurality of items of the data based on a reference frequency and a processing time taken for restoration of the data identified by the first identifier associated with the item that are obtained for each of the plurality of items of the data; and
registering, in the definition information, the decided first item name and a condition for executing predetermined processing in such a manner that the first item name and the condition are associated with each other.

10. The method according to claim 1, wherein:
the second determining determines that the received data is restored in a case where it is determined by the first determining that the information satisfies the condition,
the method further comprising:
restoring the data in a case where it is determined by the second determining that the received data is restored.

11. The method according to claim 10, further comprising:
discarding the received data in a case where it is determined by the first determining that the information does not satisfy the condition.

12. A system comprising:
a first apparatus including a first processor and a first memory coupled to the first processor; and
a second apparatus including a second processor and a second memory coupled to the second processor,
wherein the first processor of the first apparatus is configured to:
transmit, to the second apparatus, a first identifier for identifying a type of data stored in definition information, the definition information including the first identifier and a condition for executing predetermined processing that are associated with each other,
receive the data including a second identifier for identifying a type of data from the second apparatus,
determine whether or not information in a predetermined region of the received data satisfies the condition associated with the first identifier in the definition information in a case where the second identifier included in the received data matches the first identifier in the definition information, and
determine whether or not the received data is restored based on a result of the determining, and
wherein the second processor of the second apparatus is configured to:
receive the first identifier transmitted from the first apparatus, and
transmit, to the first apparatus, the data including the first identifier in a case where the data identified by the received first identifier is transmitted to the first apparatus.

13. The system according to claim 12, wherein the first processor of the first apparatus is configured to:
decide a first type among a plurality of types based on a reception frequency of data and a processing time taken for restoration of the data that are obtained for each of the plurality of types, and
register, in the definition information, a third identifier for identifying the decided first type and a condition for executing predetermined processing in such a manner that the third identifier and the condition are associated with each other.

14. The system according to claim 12, wherein the first processor of the first apparatus is configured to:
decide a second type among a plurality of types based on a transmission frequency of data and a processing time taken for encoding the data that are obtained for each of the plurality of types, and
register, in the definition information, a fourth identifier for identifying the decided second type and a condition for executing the predetermined processing in such a manner that the fourth identifier and the condition are associated with each other.

15. The system according to claim 12, further comprising:
a computer including a third processor, and
wherein the first processor of the first apparatus is configured to:
transmit, to the computer, a reception frequency of data and a processing time taken for restoration of the data that are obtained for each of a plurality of types,
receiving a fifth identifier for identifying a third type from the computer, and
register, in the definition information, the received fifth identifier and a condition for executing the predetermined processing in such a manner that the fifth identifier and the condition are associated with each other, and
wherein the third processor of the computer is configured to:
decide the third type among the plurality of types based on the reception frequency of data and the processing time taken for restoration of the data that are obtained for each of the plurality of types.

16. The system according to claim 12, wherein:
the definition information includes an item of the data that is identified by an item name associated with the first identifier and the condition for executing the predetermined processing, and
wherein the first processor of the first apparatus is configured to:
determine whether or not the information in the predetermined region of the received data satisfies the condition associated with the item of the data associated with the first identifier in the definition information in a case where the second identifier included in the received data matches the first identifier stored in the definition information.

17. The system according to claim 12, wherein the first processor of the first apparatus is configured to:
decide a first item name among item names that correspond to a plurality of items of the data based on a reference frequency and a processing time taken for restoration of the data identified by the first identifier associated with the item that are obtained for each of the plurality of items of the data, and
register, in the definition information, the decided first item name and a condition for executing predetermined processing in such a manner that the first item name and the condition are associated with each other.

18. The system according to claim 12, wherein the first processor of the first apparatus is configured to:
determine that the received data is restored in a case where it is determined by the first determining that the information satisfies the condition, and
restore the data in a case where it is determined by the determining that the received data is restored.

19. The system according to claim 18, wherein the first processor of the first apparatus is configured to:
discard the received data in a case where it is determined by the determining that the information does not satisfy the condition.

20. A non-transitory storage medium that stores a program for causing a computer to execute a process, the process comprising:
receiving data;
first determining whether or not information in a predetermined region of the received data satisfies a condition associated with a first identifier in definition information in a case where a second identifier included in the received data matches the first identifier in the definition information, the first identifier for identifying a type of data and the condition for executing predetermined processing being associated with each other and being stored in the definition information; and
second determining, based on the first determining, that the received data is restored.
